(19) United States
(12) Patent Application Publication
(10) Pub. No.: US 2003/0081192 A1
(43) Pub. Date: May 1, 2003

(54) Exposure apparatus and method using light having a wavelength less than 200 nm

(75) Inventor: Kenji Nishi, Kawasaki-shi (JP)

Correspondence Address: OLIFF & BERRIDGE, PLC, P.O. Box 19928, Alexandria, VA, 22320, US

(73) Assignee: Nikon Corporation

(21) Appl. No.: 10/271,768

(22) Filed: Oct. 17, 2002

Related U.S. Application Data
(63) Continuation of application No. 09/661,434, filed on Sep. 13, 2000.

(30) Foreign Application Priority Data
Sep. 13, 1999 (JP) 11-259621

(51) Int. Cl. G03B 27/72

(52) U.S. Cl. 355/69; 355/53; 355/67; 250/492.2; 250/492.22

(57) ABSTRACT

A first object is illuminated with illumination light, and with the first object and a second object being synchronously moved, the second object is scan-exposed with the illumination light that has passed a pattern on the first object. Ultraviolet pulse light obtained by wavelength-converting pulse laser light amplified by a fiber optical amplifier is used as the illumination light, and with measuring, on the optical path up to the second object, an intensity of the ultraviolet pulse light on a plurality-of-pulse basis or on a predetermined-time-interval basis; and an exposure amount on the second object is controlled based on the measurement results.

### BACKGROUND OF THE INVENTION

1. Field of the Invention

The present invention relates to an illumination optical apparatus that generates illumination light of, for example, ultraviolet range and, more particularly, is suitably used in an illumination optical system of an exposure apparatus used in a photolithography process for manufacturing micro devices such as semiconductor devices, image pick-up devices (such as CCDS), liquid crystal display devices, plasma display devices, and thin film magnetic heads.

2. Related Background Art

An exposure apparatus used in a photolithography process for manufacturing, for example, semiconductor integrated circuits projects and exposes a circuit pattern precisely drawn on a reticle as a mask (photomask), the projected size of the pattern being optically reduced, onto a wafer as a substrate coated with photoresist. One of the simplest and most effective ways to further decrease the minimum pattern size (resolution) on the wafer being exposed by the exposure process is to shorten the wavelength (exposure wavelength) of illumination light for exposure (exposure light) from an exposure light source in an illumination optical system. Along with realization of shortening the wavelength of the exposure light, several related requirements for configuring the exposure light source will be described next.

First, a light power output of, for example, several watts is required. This is necessary to increase throughput by shortening the time required to expose and transfer the integrated circuit pattern.

Second, when the exposure light is ultraviolet light having a wavelength of 300 nm or less, only a few kinds of optical materials are usable as a refracting element (lens) of a projection optical system, and thus chromatic aberration correction has become increasingly difficult. This necessitates the monochromaticity of the exposure light, and its spectral bandwidth is required to be made about 1 pm or less.

Third, because the spectral bandwidth narrowing entails increased temporal coherence (coherency), irradiation with the light with a narrow spectral bandwidth (wavelength width) as it is causes an undesired interference pattern called speckle. Therefore, to control the generation of the speckle, spatial coherence of the exposure light source is required to be decreased.

Among conventional short wavelength light sources meeting those requirements are, on one hand, light sources utilizing an excimer laser whose oscillation wavelength itself is short and are, on the other hand, light sources utilizing harmonic wave generation from a laser of infrared or visible range.

Of the light sources above, as the former type short wavelength light source, KrF excimer lasers (of 248 nm wavelength) are currently used, and exposure apparatuses incorporating an ArF excimer laser of further shorter wavelength (193 nm) are now being developed. Still further, the use of F₂ lasers (of 157 nm wavelength), which is a kind of excimer laser, is also proposed. However, those excimer lasers are large-sized, and because their oscillation frequency is about several kHz at present, to increase the irradiation energy per unit time, the output energy per pulse should be increased. Accordingly, there have been various problems, such as a problem that transmittance of optical elements is apt to fluctuate because of so-called compaction and a problem that the maintenance of the lasers is troublesome and costs much.

On the other hand, as a method for implementing the latter type light sources, there is a method in which, utilizing the second-order nonlinear optical effect of nonlinear optical crystals, long wavelength light (infrared or visible light) is converted into ultraviolet light having shorter wavelength. For example, in “Longitudinally diode pumped continuous wave 3.5 W green laser” (L. Y. Liu, M. Oka, W. Wiechmann and S. Kubota, Optics Letters, vol. 19 (1994), p189), a laser light source in which light from a solid-state laser excited by semiconductor laser light is wavelength-converted is disclosed. In this prior art example, a method in which, utilizing a nonlinear optical crystal, laser light of 1064 nm wavelength emitted from an Nd:YAG laser is wavelength-converted to generate 4th harmonic wave of 266 nm wavelength is described. Note that “solid-state laser” is a generic term for lasers of which laser medium is a solid.

Further, for example, in Japanese Laid-open Patent Application Japanese Patent No. Hei 8-334803 (1996) and U.S. Pat. No. 5,838,709 corresponding thereto, an array laser, in which a plurality of laser segments each comprising a laser light generating portion provided with a semiconductor laser and comprising a wavelength converting portion that wavelength-converts the light from the laser light generating portion into ultraviolet light by utilizing a nonlinear optical crystal are bundled into a matrix-like form (e.g., 10×10), is proposed.

Relative to the prior art array laser having the above-described structure, while controlling the light output from each laser segment at a low level, the total light output of the entire laser apparatus can be made high; accordingly the load on each nonlinear optical crystal can be decreased. At the same time, however, because the laser segments are independent of each other, when considering application of the array laser to exposure apparatuses, it is required that the respective oscillation wavelengths, as a whole, be coincided within a full wavelength width of about 1 pm or less.

To meet the requirement by, for example, making all of the laser segments autonomously oscillate in a single longitudinal mode having an identical wavelength with each other, it has been necessary to separately adjust the length of the resonator of each laser segment or to place a wavelength selecting element in the resonator. However, those methods have had problems, such as a problem that its adjustment is delicate and a problem that as the number of the constituent laser segments increases, more complex system to make all of the laser segments oscillate at an identical wavelength with each other is necessitated.

Alternatively, as a method for actively equalizing the wavelengths of such plural laser segments, also the injection seed method is well known (see, for example, Walter Koechner, “Solid-state Laser Engineering”, 3rd Edition, Springer Series in Optical Science, Vol.1, Springer-Verlag, ISBN0-387-53756-2, pp. 246-49). In this method, light from a single laser light source with a narrow oscillation spectral bandwidth is branched into a plurality of laser segments, and by using the laser light as seed light, all of the oscillation wavelengths of the laser segments are tuned to each other, and also the spectral bandwidths are narrowed. However, because this method requires an optical system for branching the seed light into each laser segments and a tuning control portion for tuning the oscillation wavelengths, there has been a problem that the method implementing system is complex in structure.

Furthermore, although the overall dimensions of such an array laser can be made much smaller compared with conventional excimer lasers; nevertheless, it has been difficult to realize packing that can limit the overall output beam diameter of the array laser to several cm or less. In addition, relative to the array laser configured in such manners, there have been such problems as: that each laser segment must be provided with a wavelength converting portion, resulting in high cost and that with respect to the laser segments constituting the array laser, if misalignment of one or some of the laser segments or damage of the optical element(s) thereof is found, in order to readjust or rebuild the laser segments, it has been required that the entire array laser be disassembled to extract the laser segment(s) and after the readjustment or rebuilding of the laser segment(s), the array laser be reassembled.

In this connection, when light sources that can resolve the above-described problems are developed, exposure methods or apparatuses different from those utilizing conventional light sources may also result.

### SUMMARY OF THE INVENTION

It is a first object of the present invention to provide an exposure method and an exposure apparatus that utilize a small-sized light source. Further, it is a second object of the present invention to provide, by utilizing a light source having a high light-emission frequency, an exposure method and an exposure apparatus capable of high accuracy exposure amount control. Still further, it is a third object of the present invention to provide an exposure method and an exposure apparatus capable of smoothing an integrated exposure amount distribution. Also, it is a fourth object of the present invention to provide an exposure method and an exposure apparatus that utilize a light source having a wavelength converting portion that converts light of infrared or visible region emitted from a solid-state laser into ultraviolet light. Further, it is a fifth object of the present invention to provide an exposure method and an exposure apparatus suitable for utilizing a light source capable of decreasing its spatial coherence and of narrowing its spectral bandwidth. Also, it is a sixth object of the present invention to provide a device manufacturing method capable of manufacturing high-performance devices.

A first exposure method according to the present invention is an exposure method in which a first object is illuminated with illumination light and with the first object and a second object being synchronously moved, the second object is scan-exposed with the illumination light that has passed a pattern on the first object, the exposure method comprising: utilizing, as the illumination light, ultraviolet pulse light obtained by wavelength-converting pulse laser light amplified by a fiber optical amplifier; measuring, on the optical path up to the second object, an intensity of the ultraviolet pulse light as the illumination light on a plurality-of-pulse basis or on a predetermined-time-interval basis; and controlling an exposure amount on the second object based on the measurement results.

In accordance with the first exposure method, as seed light for the fiber optical amplifier, single-wavelength laser light of from infrared to visible range with a narrow oscillation spectral bandwidth generated from a DFB (distributed feedback) semiconductor laser, a fiber laser, or the like is utilized. Further, as the fiber optical amplifier, for example, an erbium-doped fiber amplifier (EDFA), an ytterbium-doped fiber amplifier (YDFA), praseodymium-doped fiber amplifier (PDFA), a thulium-doped fiber amplifier (TDFA), or the like may be utilized. Further, the wavelength converting portion can, by applying a combination of 2nd harmonic wave generation (SHG) and/or sum frequency generation (SFG) effected by a plurality of nonlinear optical crystals, easily outputs ultraviolet light constituted of a harmonic wave having a frequency of any integral multiple of that of a fundamental wave (in terms of wavelength, an integral fraction). Such a “fiber optical amplifier type light source” is small-sized and facilitates maintenance, and its light-emission frequency can be raised to a frequency within, by way of example, a range of from 10 kHz to 1 MHz, preferably to about 100 kHz and up.

In contrast, with respect to KrF or ArF excimer laser light sources mainly used in the past, their light-emission frequency is at most about 2 kHz, and their pulse-by-pulse energy fluctuation per is relatively large. It is therefore first required that as exposure amount control during scan-exposure, each points on a substrate to be exposed be exposed with integral pulses. Further, a control method, a so-called pulse-by-pulse exposure amount control method, in which on emission completion of each pulse the exposure amount error of the pulse is determined, and the emission amount of the next pulse is controlled, is used. In contrast, with respect to light sources suitable for an exposure apparatus according to the present invention, because their light-emission frequency is so high as to be regarded as continuous light, the integral-pulse requirement can be left aside. Note that to “expose with integral pulses” means that the number of light pulses illuminating each point on the second object during scan-exposure is made to be an identical integer over all of the points.

In addition, to control emission energy pulse-by-pulse, considerably high response speed of a control system is required, and it is not very advantageous. In consideration of this, the ultraviolet pulse light intensity is measured on a plurality-of-pulse basis or on a predetermined-time-interval basis, and control in which the intensity of the ultraviolet light pulses is kept to be a predetermined intensity on an average based on the measurement results is performed. The predetermined intensity is determined in accordance with the sensitivity and scanning speed of the second object, the width in the scanning direction of the exposure area (corresponding to the illumination area of the ultraviolet light) on the second object, and further the light-emission frequency, etc. of the light source. This facilitates the control of the system.

Next, a second exposure method according to the present invention is an exposure method in which a first object is illuminated with illumination light from an illumination optical system, and a second object is exposed with the illumination light that has passed a pattern on the first object, the exposure method comprising: making ultraviolet light obtained by wavelength-converting a plurality of laser lights, each of which laser lights having been amplified by a fiber optical amplifier, that are bundled into an annulus-like form the illumination light; illuminating the first object with the illumination light when modified-illuminating the first object (illuminating the first object so that with respect to illuminance distribution on the pupil plane of the illumination system, the illuminance in the peripheral area is made to be higher than that on the optical axis); and illuminating the first object with light made by smoothing the intensity distribution of the illumination light when conventional-illuminating the first object (illuminating the first object so that the illuminance on the optical axis is made to be higher than that in the peripheral area).

In the second exposure method also, as its ultraviolet light source, the above-described fiber optical amplifier type light source can be used. In implementing the ultraviolet light source, by bundling a plurality of laser lights each from a fiber optical amplifier, spatial coherence is decreased, and thus speckle is hard to appear; and further, by utilizing lights that are branched from a common single-wavelength light source, no broadening of the overall spectral bandwidth of the ultimate ultraviolet light occurs. Further, in forming the bundle, taking advantage of the feature of bundling, by fixedly bundling the plurality of laser lights into an annulus-like form from the beginning, modified illumination (including annular illumination, etc.) can be realized while illuminance being kept high. Further, in such a case as when the modified illumination is changed to conventional illumination, by utilizing, e.g., a diffractive optical element (DOE), the ultraviolet light amount distribution, enhanced on an annular area around the optical axis, on the pupil plane of the illumination system is changed to light amount distribution that is enhanced on a rectangular or circular area, intersecting the optical axis, on the pupil plane. Through this, light amount loss resulting from the light amount distribution change can be decreased, and it is especially useful when modified illumination is heavily used.

Next, a third exposure method according to the present invention is an exposure method in which a first object is illuminated with illumination light and with the first object and a second object being synchronously moved, the second-object is scan-exposed with the illumination light that has passed a pattern on the first object, the exposure method comprising: providing a first light source apparatus that pulse-emits a first ultraviolet light and a second light source apparatus that can emit a second ultraviolet light of substantially the same wavelength range as that of the first ultraviolet light at a pulse frequency higher than that of the first light source apparatus; and correcting, by the second ultraviolet light, an exposure amount on the second object provided by the first ultraviolet light.

In the third exposure method, a light source, such as an excimer laser light source, with a low light-emission frequency can be used as the first light source apparatus, and the above-described fiber optical amplifier type light source can be used as the second light source apparatus. Because the latter fiber optical amplifier type light source can be made to pulse-emit with desired energy almost instantaneously, the correcting exposure can be performed. This is an effective use method of a fiber optical amplifier type light source with small output.

Next, a fourth exposure method according to the present invention is an exposure method in which a first object is illuminated with illumination light and a second object is exposed with the illumination light that has passed a pattern on the first object, the exposure method comprising: making ultraviolet light obtained by wavelength-converting a plurality of laser lights, each of which laser lights having been amplified by a fiber optical amplifier, that are bundled the illumination light; and changing a condition under which the second object is illuminated with the illumination light depending upon a divergence angle condition of a plurality of light beams constituting the illumination light.

In the fourth exposure method also, a fiber optical amplifier type light source is used, and further, light formed by bundling a plurality of light beams is used. Incidentally, while a light beam from an excimer laser or the like is substantially a parallel light beam, and thus its optical path may be deflected simply by a mirror or the like, each light beam from a fiber optical amplifier type light source is a light beam having a specific divergence angle. Accordingly, it is preferable that to optimize, for example, an incidence condition and the like of the light beam relative to an optical integrator (homogenizer), a relay optical system to meet the divergence angle be provided.

Next, a fifth exposure method according to the present invention is an exposure method in which a first object is illuminated with illumination light and with the first object and a second object being synchronously moved, the second object is scan-exposed with the illumination light that has passed a pattern on the first object, the exposure method comprising: making ultraviolet light obtained by wavelength-converting laser light amplified by a fiber optical amplifier the illumination light; illuminating the first object with the illumination light, with the illumination light passing via a field stop having an aperture placed on a plane substantially optically conjugate to the first object; and also defining the shape of a edge portion, having a direction intersecting the scanning direction of the second object, of the aperture of the field stop depending upon an integrated exposure amount distribution on the second object.

When, as a light source a fiber optical amplifier type light source is used as in the fifth exposure method, its light-emission frequency can be raised. As a result, as described above, a substrate need not necessarily be exposed with integral pulses. Taking advantage of this feature, an integrated exposure amount distribution relative to the non-scanning direction perpendicular to the

scanning direction is measured by performing scan-exposure, and if the results shows that the distribution is uneven, the illumination optical system is adjusted so that the unevenness is cancelled out. For example, the shape of the edge portion of the field stop is shaped into a wave-like form. By this, the exposure amount control accuracy (the integrated exposure amount distribution evenness) improves.

Next, a first exposure apparatus according to the present invention is an exposure apparatus in which a first object is illuminated with illumination light and with the first object and a second object being synchronously moved, the second object is scan-exposed with the illumination light that has passed a pattern on the first object, the exposure apparatus comprising: a light source apparatus provided with a laser light generating portion that generates single-wavelength laser light of from infrared to visible range as pulse light, a light amplifying portion having a fiber optical amplifier that amplifies the laser light generated by the laser light generating portion, and a wavelength converting portion that wavelength-converts the laser light amplified by the light amplifying portion by utilizing a nonlinear optical crystal; a monitoring system that measures, on the optical path up to the second object, an intensity of the ultraviolet pulse light from the light source apparatus as the illumination light on a plurality-of-pulse basis or on a predetermined-time-interval basis; and an exposure amount control system that controls an output of the light source apparatus based on the measurement results of the monitoring system.

Further, a second exposure apparatus according to the present invention is an exposure apparatus in which a first object is illuminated with illumination light from an illumination optical system, and a second object is exposed with the illumination light that has passed a pattern on the first object, wherein the illumination optical system comprises a light source apparatus provided with a laser light generating portion that generates single-wavelength laser light of from infrared to visible range as pulse light, a light branching amplifier portion that branches the laser light generated from the laser light generating portion into a plurality of lights and amplifies each of the plurality of lights via a fiber optical amplifier, and a wavelength converting portion that wavelength-converts the laser light amplified by the light amplifying portion into ultraviolet light having an annulus-like intensity distribution in a plane perpendicular to the optical axis by utilizing a nonlinear optical crystal and outputs the ultraviolet light as the illumination light; a multiple light source image forming optical system that forms a plurality of light source images from the illumination light from the light source apparatus; an optical member that is attachably placed between the light source apparatus and the multiple light source image forming optical system and smoothes an illuminance distribution in a plane perpendicular to the optical axis; and a light collecting optical system that illuminates the first object with the illumination light from the plurality of light source images.

Further, a third exposure apparatus according to the present invention is an exposure apparatus in which a first object is illuminated with illumination light and with the first object and a second object being synchronously moved, the second object is scan-exposed with the illumination light that has passed a pattern on the first object, the exposure apparatus comprising: a first light source apparatus that pulse-emits a first ultraviolet light; a second light source apparatus that can emit a second ultraviolet light of substantially the same wavelength range as that of the first ultraviolet light at a pulse frequency higher than that of the first light source apparatus; a combining optical system that transmits the first ultraviolet light from the first light source apparatus and the second ultraviolet light from second light source apparatus to a common optical path pointing toward the first object as the illumination light; a monitoring system that monitors an intensity of the illumination light on the optical path up to the second object; and an exposure amount control system that controls light emission of the second light source so as to correct an exposure amount obtained from the pulse-emitted light of first light source apparatus based on the measurement results of the monitoring system.

Further, a fourth exposure apparatus according to the present invention is an exposure apparatus in which a first object is illuminated with illumination light from an illumination optical system, and a second object is exposed with the illumination light that has passed a pattern on the first object, wherein the illumination optical system comprises a light source apparatus provided with a laser light generating portion that generates single-wavelength laser light of from infrared to visible range as pulse light, a light branching amplifier portion that branches the laser light generated from the laser light generating portion into a plurality of lights and amplifies each of the plurality of lights via a fiber optical amplifier, and a wavelength converting portion that wavelength-converts the laser light amplified by the light amplifying portion into ultraviolet light by utilizing a nonlinear optical crystal and outputs the ultraviolet light as the illumination light; a multiple light source image forming optical system that forms a plurality of light source images from the illumination light from the light source apparatus; and a relay optical system that is placed between the light source apparatus and the multiple light source image forming optical system and leads the illumination light to the multiple light source image forming optical system depending upon a divergence angle condition of a plurality of light beams constituting the illumination light.

Further, a fifth exposure apparatus according to the present invention is an exposure apparatus in which a first object is illuminated with illumination light from an illumination optical system and with the first object and a second object being synchronously moved, the second object is scan-exposed with the illumination light that has passed a pattern on the first object, wherein the illumination optical system comprises a light source apparatus provided with a laser light generating portion that generates single-wavelength laser light of from infrared to visible range as pulse light, a light amplifying portion that amplifies the laser light generated from the laser light generating portion via a fiber optical amplifier, and a wavelength converting portion that wavelength-converts the laser light amplified by the light amplifying portion into ultraviolet light by utilizing a nonlinear optical crystal and outputs the ultraviolet light as the illumination light; a light collecting optical system that illuminates the first object with the illumination light from the light source; and a field stop on which an aperture defining a field of the illumination light at a plane substantially optically conjugate to the first object, wherein the shape of a edge portion, having a direction intersecting the scanning direction of the second object, of the aperture of the field stop is defined depending upon an integrated exposure amount distribution on the second object.

The above-described exposure methods according to the present invention can be performed by the use of such exposure apparatuses. Further, through the use of a fiber optical amplifier type light source, the overall dimensions of each exposure apparatus according to the present invention can be made small, and its maintenance is facilitated.

Further, a device manufacturing method according to the present invention includes a process that transfers a pattern on a mask using an exposure method according to the present invention. Because exposure amount control accuracy improves by the use of an exposure method according to the present invention, high-performance devices can be manufactured.

### BRIEF DESCRIPTION OF THE DRAWINGS

FIGS. 1A and 1B illustrate a light source apparatus of an embodiment according to the present invention;

FIG. 2 illustrates a configuration example of a light amplifying unit in FIG. 1A;

FIGS. 3A and 3B each illustrate a configuration example of a wavelength converting portion in FIG. 1A;

FIGS. 4A and 4B each illustrate another configuration example of a wavelength converting portion in FIG. 1A;

FIG. 5 is a perspective view illustrating an exposure apparatus of a first embodiment according to the present invention;

FIGS. 6A, 6B, and 6C illustrate an exposure amount control method of the first embodiment;

FIGS. 7A, 7B, and 7C illustrate an exposure amount control method of a second embodiment according to the present invention;

FIGS. 8A, 8B, and 8C illustrate a defining method of the shape of an aperture of a fixed field stop of the first embodiment; and

FIG. 9 is a perspective view illustrating an exposure apparatus of the second embodiment according to the present invention.

### DETAILED DESCRIPTION OF THE PREFERRED EMBODIMENTS

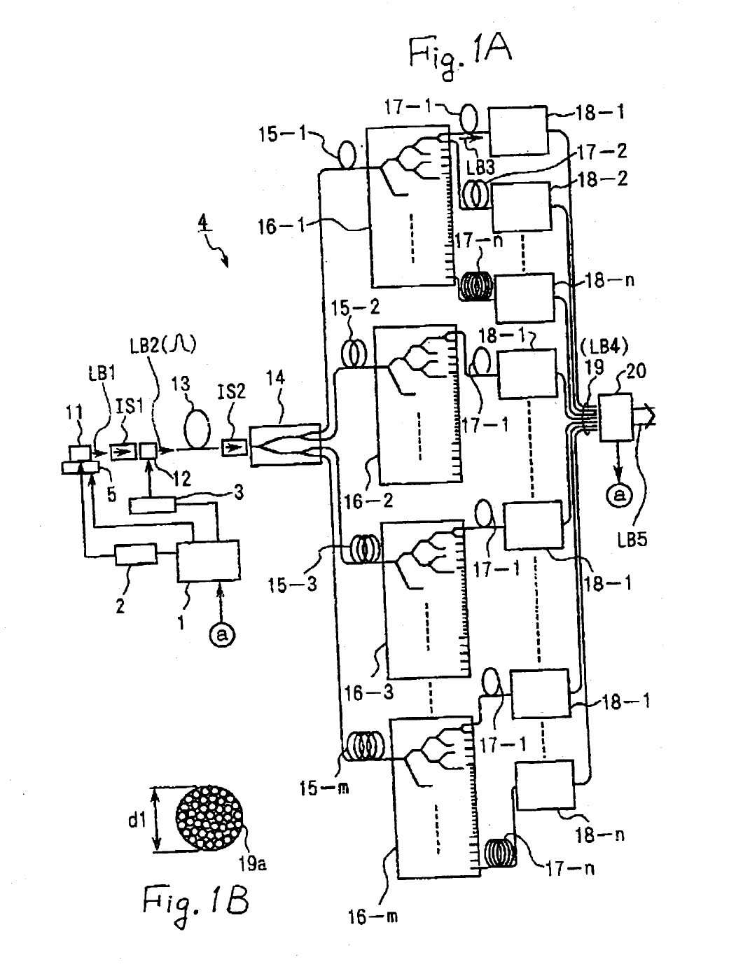

Referring to the drawings, a first embodiment according to the present invention will now be described. This embodiment is an embodiment in which the present invention is applied to a step-and-scan type exposure apparatus. FIG. 1A shows a light source apparatus for the exposure apparatus of this embodiment. In FIG. 1A, laser light LB1 of a narrow-spectral-bandwidth single wavelength of 1.544 μm, constituted of for example continuous wave, is generated from single-wavelength oscillation laser 11 as a laser light generating portion. Laser light LB1 is incident, via isolator IS1 for blocking backward light, on light modulating element 12 as a light modulating portion, where the laser light is converted into pulse laser light LB2, and then the pulse laser light is incident on light branching amplifier portion 4.

Laser light LB2 incident into light branching amplifier portion 4 is amplified through first passing through fiber optical amplifier 13 as a pre-positioned light amplifying portion, is then incident, via isolator IS2, on plate waveguide type splitter 14 as a first light branching element, and is branched into m lines of laser lights of approximately equal intensity. “m” is an integer equal to or greater than 2, and in this embodiment, m=4. AS fiber optical amplifier 13, to amplify light of the same wavelength range (in this embodiment, in the vicinity of 1.544 μm) as that of laser light LB1 generated by single-wavelength oscillation laser 11, an erbium-doped fiber amplifier (EDFA) is utilized. Additionally, pumping light of about 980±10 nm or 148±30 nm wavelength from a semiconductor laser for pumping, not shown, is supplied, via a wavelength division multiplexer for coupling, not shown, to fiber optical amplifier 13.

Note that as pumping light for an ytterbium-doped optical fiber and an erbium-ytterbium co-doped optical fiber, light of about 970±10 nm can be used.

Each of the m lines of laser lights emitted from splitter 14 is incident, each via one of optical fibers 15-1, 15-2, . . . , 15-m each having a different length, on one of plate waveguide type splitters 16-1, 16-2, . . . , 16-m as second light branching elements, and is branched into n lines of laser lights of approximately equal intensity. “n” is an integer equal to or greater than 2, and in this embodiment, n=32. The first light branching element (14) and the second light branching elements (16-1˜16-m) may also be called a light branching apparatus. Laser light LB1 emitted from single-wavelength oscillation laser 11 is thus branched into nxm lines of laser lights, in total (in this embodiment, 128 lines).

Each of n-line laser lights LB3 emitted from splitter 161 is then incident, each via one of optical fibers 17-1, 17-2, . . . 17-n each having a different length, on one of light amplifying units 18-1, 18-2, . . . , 18-n as post-positioned light amplifying portions, and is amplified thereby. Light amplifying units 18-1˜18-n amplifies light of the same wavelength range (in this embodiment, in the vicinity of 1.544 μm) as that of laser light LB1 generated by single-wavelength oscillation laser 11. Similarly, each of n-line laser lights emitted from other splitters 16-2˜16-m is incident, each via one of optical fibers 17-1, 17-2, . . . , 17-n each having a different length, on one of light amplifying units 18-1˜18-n as post-positioned light amplifying portions, and is amplified thereby.

Each of the laser lights amplified by m sets of light amplifying units 18-1˜18-n propagates through an extended portion extending from the emitting end of each of optical fibers doped with predetermined material (described later) in light amplifying units 18-1˜18-n, and the extended portions constitute optical fiber bundle 19. All of the m-set, n-line optical fiber extended portions constituting optical fiber bundle 19 have an approximately identical length. Alternatively, it may be so configured that optical fiber bundle 19 is formed by bundling mxn-line optical fibers for transmission without light amplifying effect having the same length with each other and that each of the laser lights amplified by light amplifying units 18-1˜18-n is led to one of the optical fibers for transmission. The members from fiber optical amplifier 13 up to optical fiber bundle 19 constitute light branching amplifier portion 4. It is to be noted that configuration of light branching amplifier portion 4 is not limited to the configuration illustrated in FIG. 1, and for example, a light branching apparatus may be implemented utilizing a time division multiplexer, etc.

Laser light LB4 emitted from optical fiber bundle 19 is incident on wavelength converting portion 20 having a nonlinear optical crystal and is converted into ultraviolet laser light LB5, and laser light LB5 is emitted outside as exposure light. Each of the m-set light amplifying units 18-1˜18-n corresponds to a light amplifying portion of an embodiment according to the present invention, but the optical fibers of optical fiber bundle 19 may also be included in the light amplifying portion.

Further, as illustrated in FIG. 1B, at output end 19a of optical fiber bundle 19, mxn-line (in this embodiment, 128 lines) optical fibers are so bundled that the optical fibers are closely packed and the outline of the bundle is shaped into a circle. Practically, the outline of output end 19a and the number of bundled optical fibers are determined in accordance with the configuration of the subsequent wavelength converting portion 20, conditions under which the light source of this embodiment is used, etc. Because the clad diameter of each of the optical fibers constituting optical fiber bundle 19 is about 125 μm, diameter d1 of output end 19a of fiber bundle 19 bundling 128 lines of optical fibers into a circular form can be made about 2 mm or less.

Further, wavelength converting portion 20 of this embodiment converts the incident laser light LB4 into laser light LB5 constituted of an 8th harmonic wave (in terms of wavelength, 1/8) or a 10th harmonic wave (in terms of wavelength, 1/10). Since the wavelength of laser light LB1 emitted from single-wavelength oscillation laser 11 is 1.544 μm, the wavelength of the 8th harmonic wave is 193 nm, the same as that of an ArF excimer laser, and wavelength of the 10th harmonic wave is 154 nm, nearly equal to the oscillation wavelength (157 nm) of an F₂ laser (fluorine laser). Note that when it is desirable that the wavelength of laser light LB5 is further near that of an F₂ laser, it can be so configured that a 10th harmonic wave is generated by wavelength converting portion 20 and that laser light of 1.57 μm wavelength is generated by single-wavelength oscillation laser 11.

Practically, by defining the oscillation wavelength of single-wavelength oscillation laser 11 as to be about 1.544˜1.542 μm and by converting the light into an 8th harmonic wave, ultraviolet light having a wavelength (193˜194 μm) substantially equal to that of an ArF excimer laser can be generated. Further, by defining the oscillation wavelength of single-wavelength oscillation laser 11 as to be about 1.57˜1.58 μm and by converting the light into a 10th harmonic wave, ultraviolet light having a wavelength (157˜158 μm) substantially equal to that of an F₂ excimer laser can be generated. Therefore, those types of light source apparatuses can be used, in place of an ArF excimer laser and an F₂ excimer laser, respectively, as an inexpensive light source that can be easily maintained.

It is to be noted that it may be so configured that in place of ultimately obtaining ultraviolet light of a wavelength range near that of an ArF excimer laser, an F₂ excimer, and the like, by, for example, determining an optimum exposure light wavelength (e.g., 160 nm) meeting the pattern rule of a semiconductor device and the like to be manufactured, the oscillation wavelength of single-wavelength oscillation laser 11 and the order of a harmonic wave at wavelength converting portion 20 are determined to obtain the ultraviolet light of the theoretically optimum wavelength. In other words, the wavelength of the ultraviolet light is not fixedly prescribed; rather, the oscillation wavelength of single-wavelength oscillation laser 11 and the configuration and order of a harmonic wave at wavelength converting portion 20 may be determined in accordance with a wavelength required by an apparatus to which the laser light source apparatus is applied.

Next, this embodiment will be described in more detail. In FIG. 1A, as single-wavelength oscillation laser 11 that oscillates at a single wavelength, an InGaAsP structure distributed feed back (DFB) semiconductor laser with, for example, an oscillation wavelength of 1.544 μm and a continuous wave output (hereinafter, also referred to as “CW output”) of 20 mW. Here, a DFB semiconductor laser is a laser in which, in place of a Fabry-Perot type resonator having low longitudinal mode selectivity, a diffraction grating is formed in it and which oscillates in a single longitudinal mode in any conditions. Since the DFB semiconductor laser basically oscillates in a single longitudinal mode, its oscillation spectral bandwidth can be controlled within a range of 0.01 pm. Note that as single-wavelength oscillation laser 11, a light source that generates laser light of a similar wavelength range of which oscillation wavelength is narrowed, for example, an erbium-doped fiber laser, can also be utilized.

Further, the output wavelength of the light source apparatus of this embodiment is preferably fixed at a specified wavelength to meet its usage. For this purpose, an oscillation wavelength control device for controlling the oscillation wavelength of single-wavelength oscillation laser 11, as a master oscillator, to be a constant wavelength is provided. When as single-wavelength oscillation laser 11, a DFB semiconductor laser is utilized as single-wavelength oscillation laser 11 as in this embodiment, the oscillation wavelength can be controlled by performing temperature control of the DFB semiconductor laser; and using this method, the oscillation wavelength can be controlled to be constant by further stabilizing the oscillation wavelength, or the output wavelength can be finely adjusted.

A DFB semiconductor laser and the like are usually provided on a heat sink, and they are collectively housed in a housing. Using this feature, in this embodiment, temperature adjusting portion 5 (for example, comprising a heating element such as a heater, a heat absorbing element such as a Peltier element, and a temperature detecting element such as a thermistor) is fixed to a heat sink provided on single-wavelength oscillation laser 11 (a DFB semiconductor laser and the like), and by the operation of temperature adjusting portion 5 being controlled by controller 1 constituted of a computer, the temperature of the heat sink and, by extension, of single-wavelength oscillation laser 11 are controlled accurately. The temperature of a DFB semiconductor laser and the like can thus be controlled on a 0.001° C. basis. Further, controller 1, via driver 2, accurately controls electric power (in the case of a DFB semiconductor laser, driving current) for driving single-wavelength oscillation laser 11.

Since the oscillation wavelength of a DFB semiconductor laser has a temperature dependency of about 0.1 nm/° C., when the temperature of the DFB semiconductor laser is changed, for example, by 1° C., the wavelength of the fundamental wave (1544 nm wavelength) changes by 0.1 nm. Thus, with respect to the 8th harmonic wave (193 nm), its wavelength changes by 0.0125 nm; with respect to the 10th harmonic wave (157 nm), its wavelength changes by 0.01 nm. It is to be noted that when laser light LB5 is used for an exposure apparatus, to correct, for example, imaging characteristics error due to the difference of atmospheric pressures of the ambience where the exposure apparatus is installed, errors due to the fluctuation of imaging characteristics, etc., the wavelength can be preferably changed within a range of about ±20 pm relative to the central wavelength. For this purpose, it is sufficient that the temperature of the DFB semiconductor laser can be changed within an about ±1.6° C. range for the 8th harmonic wave and within an about ±2° C. range for the 10th harmonic wave; which is practical.

Further, as a monitor wavelength utilized for feedback control for controlling the oscillation wavelength to be a required wavelength, the oscillation wavelength of single-wavelength oscillation laser 11 or a wavelength, from among harmonic wave outputs (2nd harmonic wave, 3rd harmonic wave, 4th harmonic wave, etc.) outputted by the wavelength conversion in wavelength converting portion 20 described later, that gives required sensitivity for performing the required wavelength control and can be most easily monitored can be easily selected. When as single-wavelength oscillation laser 11, a DFB semiconductor laser with, for example, an oscillation wavelength range of 1.51˜1.59 μm is utilized, the wavelength range of the 3rd harmonic wave of this oscillated laser light is 503˜530 nm, and this wavelength range corresponds to a wavelength band densely populated with iodine molecule absorption lines; and thus, by selecting an appropriate iodine molecule absorption line from them and by locking the 3rd harmonic wave on the selected wavelength, an accurate oscillation wavelength control can be performed. For this purpose, in this embodiment, a specified harmonic wave (preferably the 3rd harmonic wave) in wavelength converting portion 20 is compared with an appropriate iodine molecule absorption line (reference wavelength), the detected wavelength difference is fed back to controller 1, and controller 1 controls, via temperature adjusting portion 5, the temperature of single-wavelength oscillation laser 11 so that the difference is within a predetermined, constant value. Alternatively, controller 1 may actively change the oscillation wavelength of single-wavelength oscillation laser 11 to make the output wavelength adjustable.

The light source apparatus of this embodiment is used as a light source of an exposure apparatus, and the former type wavelength control prevents aberration occurrence of a projection optical system or the fluctuation of the aberration; and thus, the image characteristics (optical characteristics such as image quality) do not change during pattern transference.

On the other hand, the latter type wavelength control can cancel the image characteristics (aberration, etc.) fluctuation of a projection optical system due to altitude or atmospheric pressure difference between a manufacturing site where the exposure apparatus is assembled and adjusted and a location where it is installed (delivered) and further due to difference of ambience (in a clean room); and thus, time required for completing the installation of the exposure apparatus at the delivered location can be shortened. Furthermore, the latter type wavelength control, during the operation of the exposure apparatus, can also cancel the fluctuation of the aberration, projection magnification, focus position, etc. of the projection optical system caused by illumination with illumination light for exposure light, fluctuation of atmospheric pressure, reticle illumination condition (i.e., light amount distribution on a pupil plane of a illumination optical system) change by the illumination optical system, etc.; and thus, the pattern image can always be transferred onto a substrate with best imaging conditions.

Laser light LB1 constituted of continuous light outputted from single-wavelength oscillation laser 11 is, by the use of light modulating element 12 such as an electro/optical light modulating element or an acousto/optical light modulating element, converted into laser light LB2 constituted of pulse light. Light modulating element 12 is, via driver 3, driven by controller 1. Laser light LB2 outputted from light modulating element 12 of this embodiment is light modulated into, as an example, pulse light with a pulse width of about 1 ns and with a repetition frequency of about 100 kHz (pulse period of 10 μs). Such light modulation results a peak output, of the pulse light outputted from light modulating element 12, of 20 mW and an average output of 2 μW. It is here assumed that there is no loss due to the insertion of light modulating element 12, but there is actually such insertion loss. When the loss is, for example, −3 dB, the peak output of the pulse light is 10 mW, and the average output is 1 μW.

Further, by defining the repetition frequency to be about 100 kHz or more, amplification gain decrease at fiber optical amplifiers in light amplifying units 18-1˜18-n described later due to the influence of amplified spontaneous emission noise can be prevented. Still further, when it is sufficient that the illuminance of the ultraviolet light ultimately outputted is the order of that of conventional excimer laser light (having a pulse frequency of about several kHz), by increasing the pulse frequency as in this embodiment, the energy per pulse can be decreased to the order of about 1/1,000˜1/10,000; and thus, transmittance fluctuation of optical members (lenses, etc.) can be made small. Therefore, such a modulator configuration is preferable.

Further, with respect to a semiconductor laser or the like, by applying current control of it, output light can be pulse-emitted. For this purpose, in this embodiment, it is preferable that by using in parallel the electric power control of single-wavelength oscillation laser 11 (DFB semiconductor laser or the like) and light modulating element 12, the pulse light is generated. Thus, pulse light having a pulse width of, e.g., 10˜20 ns is generated by the electric power control of single-wavelength oscillation laser 11, and only a part of the pulse light is extracted by light modulating element 12; specifically, in this embodiment, the pulse light is ultimately modulated into pulse light of 1 ns pulse width.

Through this, compared with a case where only light modulating element 12 is used, pulse light with a narrow pulse width can be easily generated, and at the same time, pulse interval, starting, and stopping of the pulse light can be controlled more easily. Among other things, in case the extinction ratio is not satisfactory when the pulse light is made in an “off” state utilizing only light modulating element 12, it is preferable that the electric power control of single-wavelength oscillation laser 11 used in parallel.

The pulse light output obtained in this way is coupled to a first stage erbium-doped fiber optical amplifier 13, and a light amplification of 35 dB (3162 times) is performed on it. By this, pulse light with a peak output of about 63 mW and an average output of about 6.3 mW results. Note that a multiple-stage fiber amplifier may be utilized in place of fiber optical amplifier 13.

The output of the first stage fiber optical amplifier 13 is, by splitter 14, divided in parallel into m-piece outputs of channels 0˜m-1 (in this embodiment, m=4). By connecting each of the outputs of channels 0˜3 to optical fibers 15-1˜15-4 each having a different length, respectively, each output light from each of the optical fibers is provided with a time delay corresponding to the length of the optical fiber. Assume, for example in this embodiment, that the light propagation velocity in the fibers is 2×10⁸ m/s and optical fibers 15-1˜15-4 each of 0.1 m, 19.3 m, 38.5 m, and 57.7 m length are connected to channels 0˜3, respectively. In this case, at the output ends of the fibers, the time delay between adjacent channels is 96 ns. Note that the optical fibers 15-1˜15-4 used solely for delaying light in this manner is called here “delay fibers” for convenience' sake.

Next, each of the outputs from the 4-line delay fibers is further divided in parallel, by one of four splitters 16-1˜16-4, into n-piece (in this embodiment, n=32) outputs (each splitter having channels 0˜31) and thus divided into 4×32-piece (128 pieces) channels in total. Further, to each of the output ends of channels 0˜31 of each of the splitters 16-1˜16-4 are further connected optical fibers (delay fibers) 17-1˜17-32 each having a different length, respectively, and a time delay of 3 ns between adjacent channels is provided. Thus, a time delay of 93 ns is provided to the output of channel 31. On the other hand, with respect to the four splitters 16-1˜16-4, a time delay of 96 ns is provided between adjacent splitters by the delay fibers as described above channels. Accordingly, light pulses from 128-channel output ends in total having a time delay of 3 ns between adjacent channels are generated.

As a result, in this embodiment, the spatial coherence of laser light LB4 emitted from optical fiber bundle 19 decreases to the order of about 1/128, compared with when the sectional shape of laser light LB1 emitted from single-wavelength oscillation laser 11 is simply enlarged. Thus, it is advantageous in that the amount of speckle occurring when laser light LB5 ultimately obtained is used as exposure light is extremely small.

Through the above-described division and delay, light pulses from the 128-channel output ends in total having a time delay of 3 ns between adjacent channels are generated; and the light pulses observed at each channel of the 128 channels have a frequency of 100 kHz (pulse period of 10 μs), the same as that of the pulse light modulated by light modulating element 12. Accordingly, viewed as an overall laser light generating portion, a repetition in which a 128-pulse train with 3-ns interval is followed by a next 128-pulse train after an interval of 9.62 μs is repeated at a frequency of 100 kHz.

It is to be noted that in the above description of the example of this embodiment, the division number is assumed to be 128, and as delay fibers, those with short lengths are assumed. As a result, a 9.62 μs interval of no emission occurs between successive pulse trains; however, by increasing the division numbers m and n, by making the lengths of delay fibers longer to be appropriate lengths, or by a combination of both, all of the pulse intervals can be made to be completely even.

As can be seen from the above, splitter 14, optical fibers 15-1˜15-4, splitters 16-1˜16-m, and m-set of optical fibers 17-1˜17-n can also be regarded as constituting a time division multiplexing (TDM) means as a whole. Note that although splitters 14 and 16-1˜16-m of this embodiment are plate waveguide type splitters, other type splitters such as a fiber splitter and a beam splitter utilizing a semitransparent mirror.

In FIG. 1A, each laser light passed through m-set delay fibers (optical fibers 17-1˜17-n) is incident on light amplifying units 18-1˜18-n, respectively, and is amplified thereby. Light amplifying units 18-1˜18-n of this embodiment are provided with a fiber optical amplifier, and although a configuration examples that can be as light amplifying unit 18-1 will be next described, those examples can be similarly used as the other light amplifying units 18-2˜18-n.

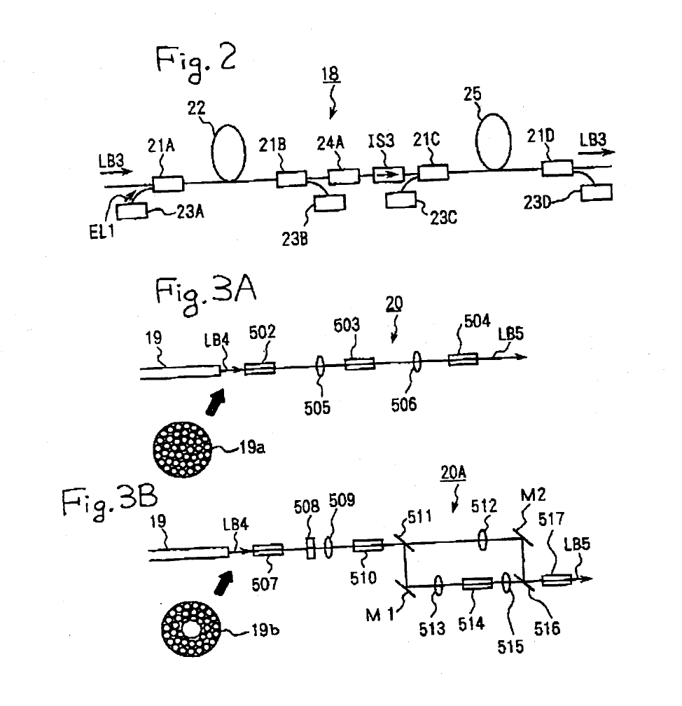

FIG. 2 shows light amplifying unit 18. In FIG. 2, amplifying unit 18 is basically constituted by connecting 2-stage fiber optical amplifiers 22 and 25 each constituted of an erbium-doped fiber optical amplifier (EDFA). Further, to each end of the first stage fiber optical amplifiers 22 are connected wavelength division multiplexing (WDM) elements (hereinafter, referred to as “WDM element”) 21A and 21B for coupling pumping light, respectively, and pumping light EL1 from semiconductor laser 23A as a pumping light and pumping light from semiconductor laser 23B as a pumping light source are supplied to fiber optical amplifiers 22 from each end by WDM elements 21A and 21B. Similarly, to each end of the second stage fiber optical amplifiers 25 are connected WDM elements for coupling 21C and 21D, respectively, and pumping lights from semiconductor lasers 23C and 23D are respectively supplied to fiber optical amplifiers 25 from each end by WDM elements 21C and 21D. Namely, fiber optical amplifiers 22 and 25 are each a bidirectional-pumping type amplifier.

Each of fiber optical amplifiers 22 and 25 amplifies light of a wavelength range of, e.g., about 1.53˜1.56 μm including the wavelength (of 1.544 μm wavelength in this embodiment) of the incident laser light LB3. Further, between WDM elements 21B and 21C, which constitute the boundary portion of fiber optical amplifiers 22 and 25, are positioned narrow band filter 24A and isolator IS3 for blocking backward light. As narrow band filter 24A, a multilayer filter or a fiber Bragg grating can be utilized.

In this embodiment, laser light LB3 from optical fiber 17-1 of FIG. 1A is, via WDM element 21A, incident on fiber optical amplifier 22 and amplified thereby. Laser light LB3 amplified by fiber optical amplifier 22 is, via WDM element 21B, narrow band filter 24A, isolator IS3, and WDM element 21C, incident on fiber optical amplifier 25 and amplified again thereby. The amplified laser light LB3, via WDM element 21D, propagates through one of the optical fibers constituting optical fiber bundle 19 of FIG. 1A (which may be an extended portion extending from the emitting end of fiber optical amplifier 25).

In this case, the total amplification gain obtained by the 2-stage fiber optical amplifiers 22 and 25 is, as an example, about 46 dB (39810 times). Assuming that the total channel number (mxn channels) from splitters 16-1˜16-m of FIG. 1A is 128 and that the average output of each channel is about 50 μw, the total average output of all channels is about 6.4 mW. When the laser light from each channel is each amplified with about 46 dB, the average output of each laser light outputted from each of light amplifying units 18-1˜18-n is about 2 W. Assuming that the laser light is converted into pulse light with a pulse width of 1 ns and a pulse frequency of 100 kHz, the peak output of each laser light is 20 kW. Further, the average output of laser light LB4 outputted from optical fiber bundle 19 is about 256 W.

Although no connection loss at splitters 14 and 16-1˜16-m is taken into consideration, if such connection loss exists, by increasing an amplification gain of at least one of fiber optical amplifiers 22 and 25 by an amount corresponding the loss, the laser light outputs of all channels can be smoothed to the above-described values (e.g., to the 20 kW peak output).

In the configuration example of FIG. 2, narrow band filter 24A substantially narrows the spectral bandwidth of the transmitting light, by cutting ASE (amplified spontaneous emission) light generated at each of fiber optical amplifier 13 of FIG. 1A and fiber optical amplifier 22 of FIG. 2 and also by making the laser light (of a spectral bandwidth of about 1 pm or less) outputted from single-wavelength oscillation laser 11 of FIG. 1A. By this, laser light amplification decrease due to the incidence of the ASE light into the post-positioned fiber optical amplifier 25 can be prevented. Here, although the transmittance spectral bandwidth of narrow band filter 24A is preferably about 1 pm, because the spectral bandwidth of the ASE light is about several ten nm, even by using a narrow band filter having a transmittance spectral bandwidth of about 100 pm available at present, the ASE light can be cut without causing any practical problems. Also, the influence of backward light is decreased through isolator IS3. Light amplifying unit 18 can also be configured by connecting, for example, 3 or more stages of fiber optical amplifiers.

Further, because in this embodiment the output lights from a number of light amplifying units 18 are bundled and used, the intensity distribution of all of the output lights are preferably smoothed. To accomplish this, for example, by extracting part of laser light LB3 emitted from WDM element 21D and by monitoring the light amount of the emitted laser light LB3 through photoelectric conversion of the extracted light, the outputs of the pumping light sources (semiconductor lasers 23A˜23D) associated with each light amplifying unit 18 may be controlled so that the monitored light amounts are approximately smoothed over all of light amplifying units 18. For this purpose, in FIG. 1A, the m-set light amplifying units 18-1˜18-n of this embodiment are so configured that the output of each unit can be independently controlled and that each set is independently attachable. By this, in such a case where the output of a certain light amplifying unit 18-i has decreased, only the light amplifying unit should be replaced, which facilitates the maintenance.

Further, when a little decrease of light utilization efficiency is allowed, i.e., when, for example, the annular illumination method or a modified light source method utilizing lights from a plurality of light source images is applied, only the amplification gains of necessary portions of light amplifying units 18-1˜18-n may be increased.

It is to be noted that in the above-described embodiment, although as single-wavelength oscillation laser 11 a laser light source with an oscillation wavelength of about 1.544 μm is utilized, instead of the laser light source a laser light source with an oscillation wavelength of about 1.099˜1.106 μm may be utilized. As such a light source, a DFB semiconductor laser or an ytterbium-doped fiber laser can be utilized. In this case, as a fiber optical amplifier in the post-positioned light amplifying portion, an ytterbium-doped optical fiber amplifier (YDFA) that amplifies light of a wavelength range of about 990˜1200 nm including the oscillation wavelength may be utilized. In this case, by a 7th harmonic wave being outputted at wavelength converting portion 20 of FIG. 1, ultraviolet light of 157˜158 nm wavelength substantially the same as that of a F₂ laser can be obtained. Practically, by defining the oscillation wavelength to be about 1.1 μm, ultraviolet light having almost the same wavelength as that of a F₂ laser can be obtained.

Further, it may be so configured that by defining the oscillation wavelength at single-wavelength oscillation laser 11 to be in the vicinity of 990 nm, a 4th harmonic wave of the fundamental wave is outputted at wavelength converting portion 20. By this, ultraviolet light of 248 nm wavelength, the same as that of a KrF laser, can be obtained.

It is to be noted that it is preferable that with respect to the last-stage, high-peak-output fiber optical amplifier of the above-described embodiment (e.g., fiber optical amplifier 25 in light amplifying unit 18 of FIG. 2), to evade the broadening of the spectral width of the amplified light due to the nonlinear effect in the fiber, a large mode diameter fiber optical amplifier having a fiber mode diameter of, for example, 20˜30 μm larger than a fiber mode diameter (5˜6 μm) normally used for communication use is utilized.

Further, to obtain high output at the last-stage fiber optical amplifier (e.g., fiber optical amplifier 25 of FIG. 2), in place of the large mode diameter fiber optical amplifier, a double clad fiber having a dual fiber clad structure may be utilized. In the optical fiber, ions contributing to laser light amplification are doped in its core portion, and the amplified laser light (signal) propagates through the core. Semiconductor laser light for pumping is coupled to a first clad surrounding the core. Because the first clad operates in a multi-mode and its sectional area is large, it easily transmits high-output semiconductor laser light for pumping and efficiently couples to multi-mode oscillation semiconductor laser light, and thus the light source for pumping can be efficiently used. A second clad for forming the waveguide of the first clad is formed around the periphery of the first clad.

Further, as the fiber optical amplifier of the above-described embodiment, a quartz fiber or a silicate fiber can be utilized; besides, a fluoride fiber, e.g., a ZBLAN fiber may also be utilized. With respect to the fluoride fiber, erbium dope density can be increased compared with a quartz fiber or a silicate fiber; and thus the required fiber length for amplification can be decreased. The fluoride fiber is, in particular, preferably applied to the last-stage fiber optical amplifier (fiber optical amplifier 25 of FIG. 2), and the decrease of the fiber length effects in preventing the broadening of the spectral width of pulse light due to the nonlinear effect during its propagation through the fiber; and thus a light source with narrowed spectral width required for, e.g., an exposure apparatus can be obtained. In particular, the fact that the narrow spectral bandwidth light source can be utilized in an exposure apparatus having a projection optical system with a large numerical aperture advantageously effects in, for example, designing and manufacturing the projection optical system. Further, an optical fiber having phosphate glass or bismuth oxide glass (Bi₂O₃B₂O₃) as its main material may be utilized as, in particular, the last-stage fiber optical amplifier. Here, with respect to a phosphate glass optical fiber, rare earth elements (e.g., Er or both of Er and Yb) can be densely doped in its core; and the required fiber length for obtaining the same amplification rate relative to the conventional quartz glass optical fiber can be a fraction of about 1/100. Further, with respect to a bismuth oxide glass optical fiber, compared with to the conventional quartz glass, the dope amount of erbium (Er) can be increased to about 100 times or more, so that a similar effect to that of phosphate glass can be obtained.

By the way, when as the output wavelength of a fiber optical amplifier having a double clad structure, 1.51˜1.59 μm wavelength range is used as described above, as an ion to be doped, ytterbium (Yb) is preferably doped in addition to erbium (Er); for this effects the improvement of the semiconductor laser light pumping efficiency. Specifically, when erbium and ytterbium are co-doped, because there extend intense absorbing lines of ytterbium in the vicinity of 915˜975 nm wavelength range, by combining a plurality of semiconductor lasers each having a different oscillation wavelength in the vicinity of this wavelength range by wavelength division multiplexing (WDM), by coupling them to the first clad, and thus by being able to utilize the plurality of semiconductor lasers as pumping light, a great pumping intensity can be realized.

Further, in designing a doped fiber of a fiber optical amplifier, with respect to an apparatus operating at a predetermined wavelength (e.g., an exposure apparatus) as in this embodiment, it is preferable that a material to be doped is selected so that the gain of the fiber optical amplifier is high at a desired wavelength. For example, with respect to an ultraviolet light source for obtaining the same output wavelength (193˜194 nm) as that of an ArF excimer laser (193˜194 nm), when a fiber for the fiber optical amplifier is used, a material by which the fiber has a high gain at a desired wavelength, for example, 1.548 μm, is preferably selected. Specifically, aluminum, an element to be doped, has an effect shifting a peak in the vicinity of 1.55 μm to longer wavelength side; and phosphorus has an effect shifting the peak to shorter longer wavelength side. Thus, to make the gain higher in the vicinity of 1.547 μm, a small amount of phosphorus should be doped. Similarly, also, for example, when a fiber for the fiber optical amplifier having a core co-doped with erbium and ytterbium (e.g., its double clad type fiber) is utilized, by adding a small amount of phosphorus into the core, a higher gain in the vicinity of 1.547 μm can be obtained.

Next, configuration examples of wavelength converting portion 20 of the ultraviolet light generation apparatus (light source) of FIG. 1 will be described.

FIG. 3A shows wavelength converting portion 20 capable of obtaining an 8th harmonic wave by repeating 2nd harmonic wave generation. In FIG. 3A, laser light LB4, a fundamental wave, of 1.544 μm wavelength (in terms of frequency, of ω) emitted from output end 19a of optical fiber bundle 19 is incident on first-stage nonlinear optical crystal 502, and here a 2nd harmonic wave of a frequency of 2 ω (in terms of wavelength, 772 nm, a half of that of the fundamental wave), two times of that of the fundamental wave, is generated by 2nd harmonic wave generation. The 2nd harmonic wave is, via lens 505, incident on second-stage nonlinear optical crystal 503, and here again through 2nd harmonic wave generation, a 4th harmonic wave of a frequency of 4 ω (in terms of wavelength, 386 nm, a one-fourth of that of the fundamental wave), two times of that of the incident wave, i.e., four times relative to the fundamental wave, is generated. The generated 4th harmonic wave further proceed, via lens 506, to third-stage nonlinear optical crystal 504, and here again through 2nd harmonic wave generation, an 8th harmonic wave of a frequency of 8 ω (in terms of wavelength, 193 nm, a one-eighths of that of the fundamental wave), two times of the frequency 4 ω of the incident wave, i.e., eight times relative to the fundamental wave, is generated. The 8th harmonic wave is emitted as the ultraviolet laser light LB5. In other words, in this configuration example, a series of wavelength conversions, the fundamental wave (1.544 μm wavelength)→the 2nd harmonic wave (772 nm wavelength)→the 4th harmonic wave (386 nm wavelength)→the 8th harmonic wave (193 nm wavelength), is performed.

As nonlinear optical crystals used for the above-described wavelength conversions, for example, a LiB₃O₅ (LBO) crystal is used as nonlinear optical crystal 502 that converts the fundamental wave into the 2nd harmonic wave; a LiB₃O₅ (LBO) crystal is used as nonlinear optical crystal 503 that converts the 2nd harmonic wave into the 4th harmonic wave; and a Sr₂Be₂B₂O₇ (SBBO) crystal is used as nonlinear optical crystal 504 that converts the 4th harmonic wave into the 8th harmonic wave. Here, for the wavelength conversion from the fundamental wave into the 2nd harmonic wave utilizing an LBO crystal, a matching method, via temperature adjustment of the LBO crystal, for implementing the phase matching for the wavelength conversion (non-critical phase matching: NCPM) is used. Because NCPM does not cause “walk-off”, an angular deviation between a fundamental wave and a 2nd harmonic wave in an optical crystal, it enables an efficient conversion into the 2nd harmonic wave and is advantageous because the beam shape deformation of the generated 2nd harmonic wave does not occur.

It is to be noted that in FIG. 3A, to increase the incidence efficiency of laser light LB4, a collector lens is preferably provided between optical fiber bundle 19 and nonlinear optical crystal 502. In implementing such configuration, since the mode diameter (core diameter) of each of the optical fibers constituting optical fiber bundle 19 is, for example, about 20 μm and the area having a high conversion efficiency in the nonlinear optical crystal is, for example, about 200 μm, it may also be so configured that by providing a micro lens of about lox magnification on each optical fiber, laser light emitted from each optical fiber is collected into optical crystal 502. This holds also for the following configuration examples.

Next, FIG. 3B shows wavelength converting portion 20A capable of obtaining an 8th harmonic wave by applying a combination of 2nd harmonic wave generation and sum frequency generation. In FIG. 3B, as shown in its enlarged view, a number of (for example, 128) optical fibers are bundled into an annulus-like form. This is suitable when modified illumination is performed. Laser light LB4, a fundamental wave, of 1.544 μm wavelength emitted from output end 19b of optical fiber bundle 19 is incident on first-stage nonlinear optical crystal 507 constituted of an LBO crystal and controlled by the above-described NCPM, and here a 2nd harmonic wave is generated by 2nd harmonic wave generation. Further, a part of the fundamental wave as it is transmits through nonlinear optical crystal 507. The fundamental wave and the 2nd harmonic wave, both in a linearly polarized status, transmit through wave plate 508 (e.g., half wave plate) with only the polarization direction of the fundamental wave being rotated by an angle of 90 degrees. Both of the fundamental wave and the 2nd harmonic wave are, each passing through lens 509, incident on second-stage nonlinear optical crystal 510.

At nonlinear optical crystal 510, a 3rd harmonic wave is obtained from the 2nd harmonic wave generated at first-stage nonlinear optical crystal 507 and the fundamental wave transmitted without being converted by sum frequency generation As nonlinear optical crystal 510, an LBO crystal is used, but it is used under an NCPM operated in a different temperature from that of first-stage nonlinear optical crystal 507 (LBO crystal). The 3rd harmonic wave obtained at nonlinear optical crystal 510 and the 2nd harmonic wave transmitted without being wavelength-converted are divided by dichroic mirror 511, and the 3rd harmonic wave reflected by dichroic mirror 511 is, being reflected by mirror M1 and passing through lens 513, incident on third-stage nonlinear optical crystal 514 constituted of a β-BaB₂O₄ (BBO) crystal. Here, the 3rd harmonic wave is converted into a 6th harmonic wave by 2nd harmonic wave generation.

On the other hand, the 2nd harmonic wave passed through the dichroic mirror is, via lens 512 and mirror M2, incident on dichroic mirror 516, and also the 6th harmonic wave obtained by nonlinear optical crystal 514 is, via lens 515, incident on dichroic mirror 516; and then the 2nd harmonic wave and the 6th harmonic wave are here coaxially combined and are incident on fourth-stage nonlinear optical crystal 517 constituted of a BBO crystal. At nonlinear optical crystal 517, an 8th harmonic wave (193 nm wavelength) is obtained from the 6th harmonic wave and the 2nd harmonic wave by sum frequency generation. The 8th harmonic wave is emitted as the ultraviolet laser light LBS. Note that as fourth-stage nonlinear optical crystal 517, in place of a BBO crystal, a CsLiB₆O₁ (CLBO) crystal can also be used. In wavelength converting portion 20A, a series of wavelength conversions, the fundamental wave (1.544 μm wavelength)→the 2nd harmonic wave (772 nm wavelength)→the 3rd harmonic wave (515 nm wavelength)→the 6th harmonic wave (257 nm wavelength)→the 8th harmonic wave (193 nm wavelength), is performed.

In the configuration in which one of the 6th harmonic wave and the 2nd harmonic wave passes through a branching optical path, lenses 515 and 512 for collecting the 6th harmonic wave and the 2nd harmonic wave, respectively, and making them incident on fourth-stage nonlinear optical crystal 517 can each be separately positioned on a different optical path. In this case, because the sectional form of the 6th harmonic wave generated by third-stage nonlinear optical crystal 514 has an elliptic form due to the walk-off effect, it is preferable that beam form adjustment of the 6th harmonic wave is performed to obtain a good conversion efficiency at fourth-stage nonlinear optical crystal 517. For this purpose, by positioning the lenses 515 and 512 on separate optical paths as in this embodiment, as, for example, lens 515, a pair of cylindrical lenses can be used; and thus the beam form adjustment of the 6th harmonic wave can be easily performed. As a result, by increasing the overlapping area of the 6th harmonic wave and the 2nd harmonic wave at fourth-stage nonlinear optical crystal 517 (BBO crystal), the conversion efficiency can be increased.

It is to be noted that configuration between second-stage nonlinear optical crystal 510 and fourth-stage nonlinear optical crystal 517 should not be limited to the configuration illustrated in FIG. 3A, and any configuration, provided that each optical path length of the 6th harmonic wave and the 2nd harmonic wave has the same length so that the 6th harmonic wave and the 2nd harmonic wave are simultaneously incident on fourth-stage nonlinear optical crystal 517, may be adopted. Further, for example, by positioning third-stage nonlinear optical crystal 514 and fourth-stage nonlinear optical crystal 517 on the same optical axis as that of second-stage nonlinear optical crystal 510, with only the 3rd harmonic wave being converted into a 6th harmonic wave by 2nd harmonic wave generation, the 6th harmonic wave along with the 2nd harmonic wave without being wavelength-converted may be made incident on fourth-stage nonlinear optical crystal 517, which dispenses with the use of dichroic mirrors 511 and 516.

In addition, with respect to wavelength converting portion 20 illustrated in FIG. 3A, the average output of the 8th harmonic wave (193 nm wavelength) per channel was experimentally determined. As described in the above-mentioned embodiment, the output of the fundamental wave at each of the output ends has a peak power of 20 kW, a pulse width of 1 ns, a pulse frequency of 100 kHz, and an average output of 2 W. The experiment showed that the average output of the 8th harmonic wave per channel was 229 mW. The average output from the bundle comprising 128 channels therefore was 29 W, which can provide ultraviolet light with a sufficient output for a light source of an exposure apparatus. Also with the configuration example of FIG. 3B, a practical output can be obtained.

Note that other combinations of nonlinear optical crystals than those of wavelength converting portions 20 and 20A are available. Such a combination from among them as has a high conversion efficiency and simplified configuration is preferably used.

Next, configuration examples of wavelength converting portions for obtaining ultraviolet light having a wavelength nearly equal to the wavelength (157 nm) of an F₂ laser. In this case, defining the wavelength of the fundamental wave generated at single-wavelength oscillation laser 11 of FIG. 1A to be 1.57 μm, a wavelength converting portion, as wavelength converting portion 20, generating a 10th harmonic wave may be used.

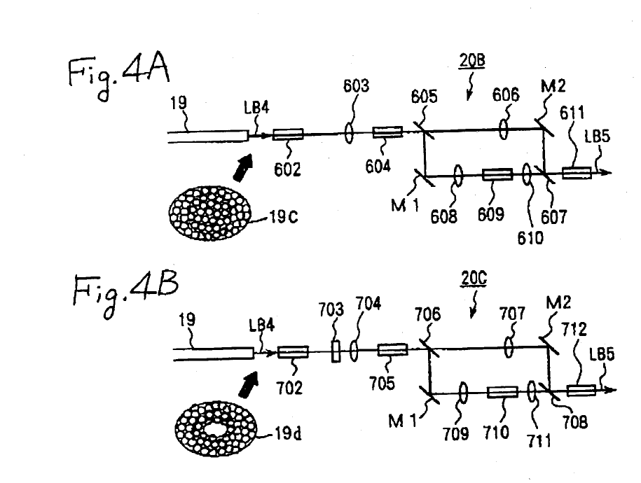

FIG. 4A shows wavelength converting portion 20B capable of obtaining a 10th harmonic wave by applying a combination of 2nd harmonic wave generation and sum frequency generation. In FIG. 4A, the output end 19c of optical fiber bundle 19 is bundled in advance into an elliptic form so that the ultimate light output form becomes to have a circular form when using cylindrical lenses or the like to decrease the influence of the walk-off effect. Laser light LB4, a fundamental wave, of 1.57 μm wavelength emitted from the output end 19c is incident on first-stage nonlinear optical crystal 603 constituted of an LBO crystal and is converted into a 2nd harmonic wave by 2nd harmonic wave generation. The 2nd harmonic wave is, via lens 603, incident on second-stage nonlinear optical crystal 604 constituted of an LBO crystal and is converted into a 4th harmonic wave by 2nd harmonic wave generation; at the same time a part of the 2nd harmonic wave as it is passes through second-stage nonlinear optical crystal 604.

The 4th harmonic wave and the 2nd harmonic wave passed through nonlinear optical crystal 604 proceed to dichroic mirror 605, and the 4th harmonic wave reflected by dichroic mirror 605 is, being reflected by mirror M1 and passing through lens 608, incident on third-stage nonlinear optical crystal 609 constituted of a Sr₂Be₂B₂O₇ (SBBO) crystal and is converted into an 8th harmonic wave by 2nd harmonic wave generation. On the other hand, the 2nd harmonic wave passed through the dichroic mirror is, via lens 606 and mirror M2, incident on dichroic mirror 607, and also the 8th harmonic wave obtained by nonlinear optical crystal 609 is, via lens 610, incident on dichroic mirror 607; and then the 2nd harmonic wave and the 8th harmonic wave are here coaxially combined and are incident on fourth-stage nonlinear optical crystal 611 constituted of a SBBO crystal, and here a 10th harmonic wave (157 nm wavelength) is obtained from the 8th harmonic wave and the 2nd harmonic wave by sum frequency generation. The 10th harmonic wave is emitted as the ultraviolet laser light LB5. In other words, in wavelength converting portion 20B, a series of wavelength conversions, the fundamental wave (1.57 μm wavelength) the 2nd harmonic wave (785 nm wavelength)→the 4th harmonic wave (392.5 nm wavelength)→the 8th harmonic wave (196.25 nm wavelength)→the 10th harmonic wave (157 nm wavelength), is performed.

In this configuration example also, without using dichroic mirrors 605 and 607, the four nonlinear optical crystals 602, 604, 609, and 611 may be positioned on a common optical axis. However, in this example, the sectional form of the 4th harmonic wave generated by second-stage nonlinear optical crystal 604 has an elliptic form due to the walk-off effect. Thus, to obtain a good conversion efficiency at fourth-stage nonlinear optical crystal 611 on which the 4th harmonic wave beam is to be incident, the beam shape of the 4th harmonic wave to be incident is preferably adjusted to increase the overlapping area of the 4th harmonic wave and the 2nd harmonic wave. Because lenses for collecting light 606 and 608 on separate optical paths in this embodiment, by using a cylindrical lens as, for example, lens 608, the beam form adjustment of the 4th harmonic wave can be easily performed. Thus, the conversion efficiency can be increased. Even in this case, because the incident beam has an elliptic form, the ultimate laser light LB5 having a circular sectional shape is emitted.

Further, to obtain ultraviolet light having a wavelength nearly equal to the wavelength (157 nm) of an F₂ laser, a method in which defining the wavelength of the fundamental wave generated at single-wavelength oscillation laser 11 of FIG. 1A to be 1.099 μm, a wavelength converting portion, as wavelength converting portion 20, generating a 7th harmonic wave is used may be used.

FIG. 4B shows wavelength converting portion 20C capable of obtaining a 7th harmonic wave by applying a combination of 2nd harmonic wave generation and sum frequency generation. In FIG. 4B, the output end 19d of optical fiber bundle 19 is bundled into an elliptic annulus-like form. Laser light LB4 (fundamental wave) of 1.099 μm wavelength emitted from the output end 19d is incident on first-stage nonlinear optical crystal 702 constituted of an LBO crystal and is here converted into a 2nd harmonic wave by 2nd harmonic wave generation with a part of the fundamental wave as it is passing through the optical crystal 702. The fundamental wave and the 2nd harmonic wave, both in a linearly polarized status, transmit through wave plate 703 (e.g., half wave plate) with only the polarization direction of the fundamental wave being rotated by an angle of 90 degrees. Both of the fundamental wave and the 2nd harmonic wave are, via lens 704, incident on second-stage nonlinear optical crystal 705 constituted of an LBO crystal, and here a 3rd harmonic wave is generated is by sum frequency generation; at the same time a part of the 2nd harmonic wave as it is passes through second-stage nonlinear optical crystal 705.

The 2nd harmonic wave and the 3rd harmonic wave generated by the nonlinear optical crystal 705 are divided by dichroic mirror 706, and the 3rd harmonic wave passed through dichroic mirror 706 is, via lens 707 and mirror M2, incident on dichroic mirror 708. On the other hand, the 2nd harmonic wave reflected by dichroic mirror 706 is, via mirror M1 and lens 709, incident on third-stage nonlinear optical crystal 710 constituted of a SBBO crystal and is converted into a 4th harmonic wave by 2nd harmonic wave generation. The 4th harmonic wave is, via lens 711, incident on dichroic mirror 708; and then the 3rd harmonic wave and the 4th harmonic wave coaxially combined by dichroic mirror 708 and are incident on fourth-stage nonlinear optical crystal 611 constituted of a SBBO crystal, and here converted into a 7th harmonic wave (157 nm wavelength) by sum frequency generation. The 7th harmonic wave is emitted as the ultraviolet laser light LB5. In other words, in this configuration example, a series of wavelength conversions, the fundamental wave (1.099 Mm wavelength)→the 2nd harmonic wave (549.5 nM wavelength)→the 3rd harmonic wave (366.3 nm wavelength)→the 4th harmonic wave (274.8 nm wavelength)→the 7th harmonic wave (157 nm wavelength), is performed.

In this configuration example also, without using dichroic mirrors 706 and 708, the four nonlinear optical crystals 702, 705, 710, and 712 may be positioned on a common optical axis. Further, in this example also, the sectional form of the 4th harmonic wave generated by third-stage nonlinear optical crystal 710 has an elliptic form due to the walk-off effect. Thus, to obtain a good conversion efficiency at fourth-stage nonlinear optical crystal 712 on which the 4th harmonic wave beam is to be incident, by using a cylindrical lens as lens 711, the overlapping area of the 3rd harmonic wave and the 4th harmonic wave is preferably maximized. Even in this case, because the output end 19d has an elliptic annulus-like form, the sectional shape of laser light LB5 outputted has an almost completely elliptic form.

Note that in the above-described embodiment, as can be seen from FIG. 1A, the combined light combining the light outputs from all of the m-set of n-piece light amplifying units 18-1˜18-n is wavelength-converted by the single wavelength converting portion 20. Instead, however, it may be so configured that for example, preparing m′-piece wavelength converting portions, m′ being an integer equal to or greater than 2, dividing the outputs of the m-set light amplifying units 18-1˜18-n into m′ groups each having n′ pieces outputs, and wavelength-converting each group by a single wavelength converting portion; and then the obtained m′ (in this embodiment, for example, m′=4 or 5) pieces ultraviolet lights are combined. Note that the number of (light amplifying unit 18) outputs, n′, at each of m′ pieces groups may be arbitrarily set, and further the number of outputs, n′, may be varied between the m′ pieces groups.

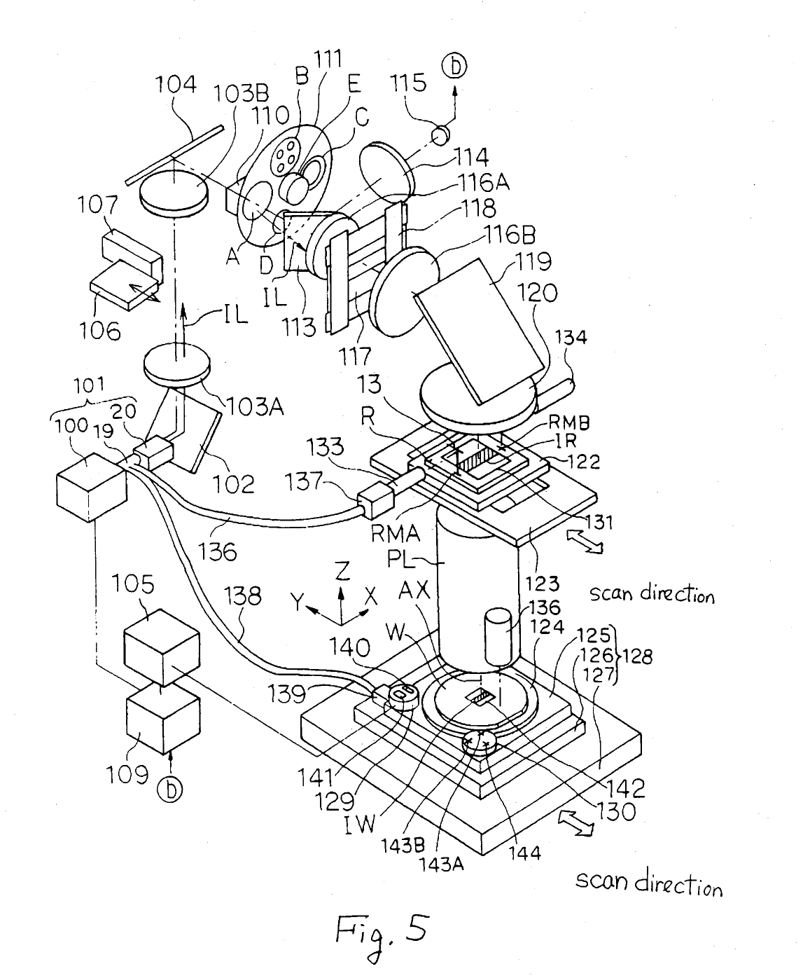

Further, as shown in FIGS. 5 and 9, by setting m′=3, i.e., providing three wavelength converting portions 20, 137, and 139 and by dividing the mxn-line optical fibers into three bundles, each of the bundles may be wavelength-converted by a corresponding wavelength converting portion. In this case, the three ultraviolet lights are not combined, but used for different purposes; and it can be so configured that by, for example, switching on/off the pumping light source of the fiber optical amplifiers, ultraviolet light emits only from any one of the wavelength converting portions.

In addition, each of the configurations shown in FIGS. 3A, 3B, 4A, and 4B is only an example, the configuration may be determined in accordance with required wavelength, intensity, etc. of a product (exposure apparatus, etc.) to which the light source apparatus of FIG. 1A is applied. Further, as a nonlinear optical crystal, for example, a CBO crystal (CsB₃O₅), tetraboric acid lithium (Li₂B₄O₇), KAB (KAl₂B₄O₇), or GdYCOB (GdₓY₁₋ₓCa₄O(BO₃)₃) may be used.

Further, the shape of the output end of optical fiber bundle 19 may be arbitrarily set independently of the configuration of the wavelength converting portion, and the shape may be determined in accordance with a product and its usage to which the light source apparatus is applied. For example, in an exposure apparatus in which modified illumination (annular illumination, modified light source method utilizing lights from a plurality of decentered light source images, etc.) is more frequently applied than conventional illumination, the shape of the output end of optical fiber bundle 19 is made to be an annulus-like form; and, as opposed to this, in an exposure apparatus in which conventional illumination is more frequently applied, the shape of the output end is made to be a circle-like, ellipse-like, or rectangle-like form.

Further, for example, in an exposure apparatus in which among modified illumination, a so-called modified light source method utilizing lights from a plurality of decentered light source images is frequently used, by making the shape of the output end of optical fiber bundle 19 to be a plurality of (e.g. 4) decentered areas, a diffractive optical element for changing the illumination light distribution may be positioned in the vicinity of the output end to address the case when annular illumination or conventional illumination is applied.

According to the light source apparatus of the above-described embodiment, because the overall diameter of the output end of optical fiber bundle 19 including all channels is about 2 mm or less, wavelength conversion of all channels can be effected by one or a few wavelength converting portions 20. Furthermore, because flexible optical fibers are used at the output end portions, for example, the wavelength converting portion, the single-wavelength oscillation laser, and the splitters can be separately positioned; thus, extremely high positioning freedom is realized. Therefore, according to the light source apparatus of this embodiment, there is provided an inexpensive and compact ultraviolet laser apparatus with low spatial coherence while being a single-wavelength oscillation laser.

Then, in FIG. 5, a step-and-scan type exposure apparatus according to this example equipped with the light source shown in FIG. 5 as an exposure light source. In FIG. 5, exposure light source 101 is composed of fundamental wave generating part 100 for generating a laser light having the wavelength of 1.544 μm (or 1.57 μm) as a fundamental wave,

optical fiber bundle 19 for transmitting the fundamental wave having flexibility, wavelength converting portion 20 for generating a vacuum ultraviolet light having a wavelength of 193 nm (or 157 nm) consisting of an 8th harmonic wave (or a 10th harmonic wave) of the fundamental wave emitted from optical fiber bundle 19 as exposure light IL. Fundamental wave generating part 100 is denoted as members from single-wavelength oscillation laser 11 to light amplifying units 18-1, . . . , 18-n within light branching amplifier portion 4 in FIG. 1A. Moreover, the light having a wavelength of 193 nm or 157 nm is convenient that it can be used as the ArF or F2 laser, respectively. Furthermore, in this example, it is constructed such that the tip of optical fiber bundle 19 is divided into a plurality of long flexible optical fiber bundles 136 and 138, wavelength converting portions 137 and 139 having same function as wavelength converting portion 20 are arranged in respective exit surfaces of optical fiber bundles 136 and 138, and the light having the same wavelength as the exposure light IL can be emitted from wavelength converting portions 137 and 139.

Timing, frequency, and pulse energy of exposure light IL emitted from exposure light source 101 is controlled by exposure controller 109, and the movement of exposure controller 109 is controlled by main controller 105 for controlling the movement of the whole apparatus.

Exposure light IL composed of the pulsed ultraviolet light having the wavelength of 193 nm (or 157 nm) emitted from exposure light source 101, after being reflected from optical path folding mirror 102, reaches fly-eye lens 110 via relay lens system composed of a first lens 103A and a second lens 103B, and through optical path folding mirror 104. Since exposure light IL exit from wavelength converting portion 20 according to this example is a combination of a plurality of light fluxes having a predetermined diverting angle, relay lens systems (103A, 103B) make, for example, exit surface of optical fiber bundle 19, that is, about central part of the non-linear optical crystal which is the last stage of wavelength converting portion 20 optically conjugate with incident surface of fly-eye lens 110, and make diverting angle of each light flux incident to fly-eye lens 110 to be optimum. Accordingly, using efficiency of exposure light IL is kept high.

Moreover, uniformizer 106 composed of diffractive optical element (DOE) removably arranged between lenses 103A and 103B by slider 107. Uniformizer 106 is a collection of a large number of minute phase gratings, and converts illumination light distribution in incident surface of fly-eye lens 110 from annular to circular. When the projection exposure apparatus according to this example is an apparatus for mainly performing modified-illumination, exit surface of optical fiber bundle 19 in exposure light source 101 is made to be annular exit surface 19b in FIG. 3B or elliptical annular exit surface 19d in FIG. 4B. When normal illumination is carried out by using this construction, uniformizer 106 is arranged across the optical path of exposure light IL. Accordingly, high illuminance is obtained while carrying out modified-illumination (an illumination using opening B or C of aperture stop plate 111 explained later), and exposure can be carried out as well with small light loss (for example, about 10%) while carrying out normal illumination (an illumination using opening A or D).

On the other hand, when the projection exposure apparatus according to this example is an apparatus for mainly performing normal illumination, exit surface of optical fiber bundle 19 in exposure light source 101 is made to be circular exit surface 19a in FIG. 3A or elliptical exit surface 19c in FIG. 4A. When modified-illumination is carried out by using this construction, in stead of uniformizer 106, for example, Diffraction Optical Element (DOE) capable of obtaining annular illuminance distribution can be arranged across optical path of exposure light IL.

Then, aperture stop plate 111 of the illumination optical system is rotatably arranged in exit surface of fly-eye lens 110, and around the rotation axis of aperture stop plate 111, there are circular aperture stop A for normal illumination, aperture stop B for modified-illumination composed of a plurality of decentered small apertures, aperture stop C for annular illumination, aperture stop D for small coherence factor (σvalue) composed of a small circular aperture. It is constructed such that an aperture stop of the illumination optical system in accordance with selected illumination condition can be arranged in exit plane of fly-eye lens 110 by rotating aperture stop plate 111 by means of driving motor E under control of main controller 105.

A portion of exposure light IL passed through aperture stop arranged in exit surface of fly-eye lens 110 is incident into integrator sensor 115 composed of photoelectric detector via collection lens 114 after being reflected from beam splitter 113. Detected signal by integrator sensor 115 is transmitted to exposure controller 109, and is converted into digital data by each pulse light by, for example, peak hold circuit and analogue/digital (A/D) converter in exposure controller 109. In this example, coefficient α (correlation coefficient) for calculating pulse energy per unit area of exposure light on the wafer as a substrate to be exposed from the digital data of the signal detected by integrator sensor 115 is obtained in advance, and the coefficient α is stored in exposure controller 109. Pulse energy on the wafer is indirectly monitored by multiplying detected signal from integrator sensor 115 by coefficient a while exposing.

Exposure light IL passed through beam splitter 113 passes through in order first relay lens 116A, fixed field stop (reticle blind) 117, and variable field stop 118. Fixed field stop 117 is a field stop for defining the shape of rectangular illumination area on reticle R, and variable field stop 118 is used for closing the illumination area not for exposing unnecessary portion when staring or finishing scan-exposure. Variable field stop 118 is arranged in a plane optically conjugate with the patterned surface of reticle R, and fixed field stop 117 is arranged in a plane defocused by a predetermined distance from the conjugate plane.

Exposure light IL passed through variable field stop 118 passes through second relay lens 116B, optical path folding mirror 119, and condenser lens 120, and illuminates narrow rectangular illumination area IR inside pattern area 131 formed on patterned surface (lower surface) of reticle R. Under exposure light IL, the pattern in illumination area IR of reticle R is carried out reduction projection onto exposure area IW on wafer W applied with photoresist through a projection optical system PL which is both sides (or wafer side only) telecentric, with a predetermined projection magnification MRW (in this example, MRW is ¼, ⅕, ⅙, etc.). Reticle R and wafer W are correspondent with the first object and the second object according to the present invention, respectively. Wafer W is a disk substrate, for example, semiconductor (silicon, etc.) or Sol (silicon on insulator), etc.

The following explanation is on assuming that Z axis is set to be parallel with the optical axis AX of the projection optical system PL, Y axis is set to be along the scanning direction of reticle R and wafer W while carrying out scan-exposure within a plane perpendicular to Z axis, and X axis is set to be along non-scanning direction perpendicular to the scanning direction SD. In this case, illumination area IR and exposure area IW are long and narrow slit shape areas along non-scanning direction (X direction) perpendicular to the scanning direction.

Moreover, reticle R is adsorptively held on reticle stage 122, and reticle stage 122 is arranged on reticle base 123, and capable of being moved continuously in Y direction by linear motor. Moreover, in reticle stage 123, a mechanism to infinitesimally move reticle R in X, Y, and rotational directions is equipped. Position and rotation angle of reticle stage 122 is measured by a laser interferometer (not shown), and movement of reticle stage 122 is controlled based on the measured data and control information from main controller 105.

On the other hand, wafer W is adsorptively held on wafer holder 124, wafer holder 124 is fixed on z tilt stage 125 for controlling focusing position (position in Z direction) and tilt angle of wafer W, Z tilt stage 125 is fixed on XY stage 126, and XY stage 126 continuously moves Z tilt stage 125 (wafer W) in Y direction and moves in stepping manner in X and Y directions on wafer base 127 by, for example, linear motor. Wafer stage 128 is composed of Z tilt stage 125, XY stage 126, and wafer base 127. Position and rotation angle of Z tilt stage 125 is measured by a laser interferometer (not shown), and movement of wafer stage 128 is controlled based on the measured data and control information from main controller 105.

When exposing, exposure light IL illuminates illumination area IR, pattern image in pattern area 131 of reticle R is successively transferred onto one shot area 142 on wafer W by scanning reticle R in +Y direction (or −Y direction) relative to illumination area IR with velocity VR via reticle stage 122 synchronizing with the scanning of wafer W in −Y direction (or +Y direction) relative to exposure area IW with velocity MRW×VR (MRW is a projection magnification from reticle R to wafer W) via XY stage 126. The reason why the scanning direction of reticle R is reverse to that of wafer W is because projection optical system PL projects image reversely, if projection optical system PL projects erected image, the scanning directions of reticle R and wafer W become same (+Y direction or −Y direction). Then, it is repeated in step-and-scan method that after the next shot area on wafer W is moved to the scanning start position by stepping XY stage 126, synchronized scanning is carried out, so that exposure to each shot area on wafer W is carried out. Then, circuit pattern of the layer is formed by pattern forming procedure such as development of photoresist on wafer W, etching, ion injection, and the like.

On carrying out these exposure, alignment between reticle R and wafer W has to be done in advance. Therefore, alignment marks RMA and RMB are formed on reticle R, alignment microscopes 133 and 134 those are imaging method as well as TTR (trough the reticle) method are arranged over alignment marks RMA and RMB via mirror 135 and the like, illumination light of alignment microscope 133 having the same wavelength of exposure light IL is supplied by wavelength converter 137 arranged at exit portion of optical fiber bundle 136, and a portion of the illumination light is supplied to alignment microscope 134. Imaging signal from alignment microscopes 133 and 134 is supplied to main controller 105.

Furthermore, on the side of projection optical system, for example, alignment sensor 136 which is the off-axis method and for detecting position of alignment marks by imaging method using white light in visible area is fixed, and imaging signal of alignment sensor 136 is also supplied to main controller 105. Then, fiducial mark member 130 on which fiducial marks 143A and 143B corresponding to marks on reticle side, and fiducial mark 144 for alignment sensor 136 are formed is fixed on Z tilt stage 125 as a sample table. Base line distance (distance between center of exposure and that of detection) of alignment sensor 136 is obtained by observing these fiducial marks 143A-143C on fiducial mark member 130 by using alignment microscopes 133 and 134, and alignment sensor 136, and alignment of each shot area on wafer W is carried out with high precision by using this base line distance.

Substrate 129 with slit opening 140 and square-like opening 141 is fixed on Z-tilt stage 125. An illumination light is led to the bottom side of slit opening 140, the wavelength of which is equal to that of the exposure light emitted from fiber bundle 138 and wavelength converting portion 139. The first photoelectric detector is located at the bottom of slit opening 140 for receiving the reflection light, while the second photoelectric detector of a greater sensing area is located on the bottom side of square-like opening 141. The detection outputs of both the photoelectric detectors are also input to main control system 105. These detection outputs are utilized for measuring various imaging characteristics.

The optimum exposure on the photoresist applied to the wafer W is predetermined. If an error in the integrated exposure on the photoresist will exceed a permissible limit, the formed line width would vary over a permissible range to result in deterioration in the production yield of the final semiconductor devices. In the projection exposure apparatus according to the present invention, the exposure is controlled by means of the detection output from integrator sensor 115 so that the error in the integrated exposure on the entire area of each shot on wafer W is held within the permissible limit.

If an excimer laser (e.g., ArF excimer laser light source) were used as the light source in the above mentioned exposure, the frequency-of exposure light would be about 2k Hz at peak pulse PE2. On the contrary, the peak level of the frequency of exposure light IL in the embodiment according to the present invention is about 100 k Hz at PE1 as in FIG. 6B, in which each of pulse portions PP1, PP2, and so on at frequency 100 k Hz is actually a set of a great number (e.g., 128) of pulses arranged in about every 3 ns intervals as in FIG. 6C. Accordingly, the necessary peak level at PE1 is about only 1/1000 to 1/10000 of that at PE2 for securing the sufficient illuminance on the wafer. In addition, an excimer laser light source would control the energy of the next pulse upon every occurrence of pulses. On the contrary, the embodiment according to the present invention does not adopt such energy control upon every pulse because of the high frequency.

But, the embodiment according to the present invention senses pulse exposure light IL of about 100 k Hz in FIG. 6B by means of integrator sensor 115 for integrating the output thereof in every n pulses (wherein n is an integer of 2 or more; e.g., 10 to 50). Exposure control system 109 converts every energy ΣE1, ΣE2, and so on, each of which is integrated in every n pulses, into corresponding illuminance PW1, PW2 and so on, for controlling the output of exposure light source 101 so that the converted illumnance PWi (i=1, 2, . . . ) may approach target value Po. Target value Po will given by the following equation defined on the exposure time D/VW as to every points on wafer W, wherein the optimum exposure (sensitivity) on the photoresist applied to the wafer W is ΣE0, the scanning velocity along Y-direction on wafer W is VW, and the width of exposure area IW on wafer W across Y-direction is D:

P₀·(D/VW)=ΣE₀ (1)

The above mentioned constant illuminance control carried out in every n pulses according to the present invention is advantageous for attaining a high accuracy of exposure control at every points on wafer W without an excessive demand of increasing the processing speed in exposure control system 109. Alternatively, the exposure control according to the present invention may be possible without integrating the detection outputs in every n pulses. For example, the same result can be attained by means of successively integrating the detection outputs caused by pulse exposure light IL for every time period ΔTPn which approximately corresponds to a time taken for the n pulses to appear, the integrated value thus obtained being used to control the exposure to attain the constant illuminance.

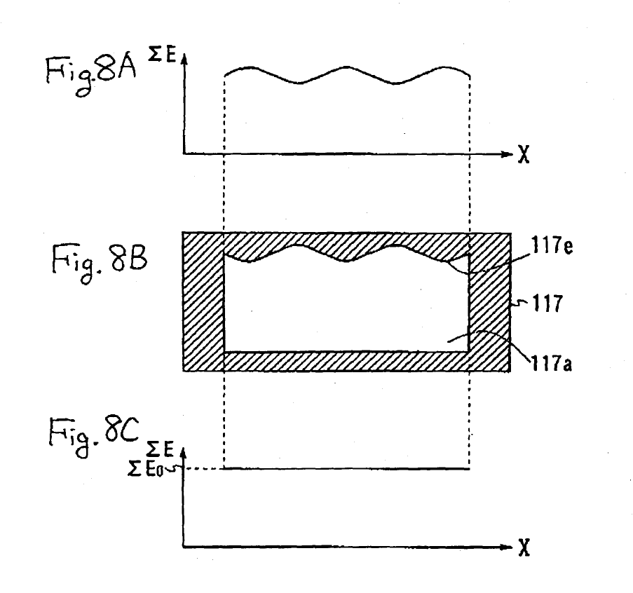

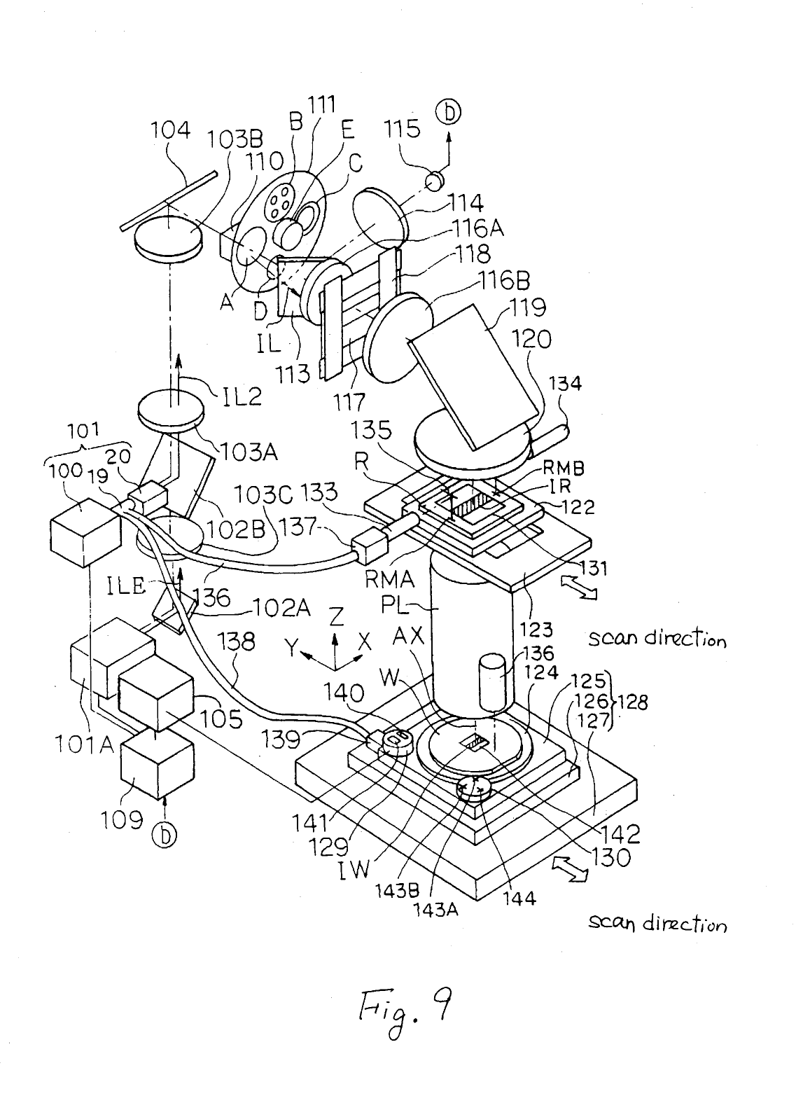

Now the explanation will be advanced to the shape of fixed field aperture 117 of the embodiment according to the present invention. FIG. 8A represents an example of a distribution of variation in integrated exposure value ΣE on wafer W along X-direction perpendicular to the scanning direction, which distribution is obtained provided that the scanning is carried out with the shape of edge of fixed field aperture 117 straight. In this situation, if the shape of opening 117a as to fixed field aperture 117 is modified into the shape as in FIG. 8B by means of narrowing a portion of a greater integrated exposure value ΣE while widening a portion of a less integrated exposure value ΣE, the shape of edge 117a with edge 117e results, the shape being a curve for canceling the distribution of variation in integrated exposure value ΣE as in FIG. 8A. Thus, the adoption of the shape of FIG. 8B as fixed field aperture 117 in FIG. 5 can attain a flat distribution of integrated exposure value ΣE as in FIG. 8C on wafer W along the direction perpendicular to the scanning direction. The attained distribution successfully coincides with the optimum exposure ΣE0.

Since distribution (dispersion) of an accumulated quantity of exposed light (accumulated light quantity) ΣE could change according to modification of illuminating conditions, it is possible to exchange fixed field stop (reticle blind) 117 of the illuminating optical system with other fixed field stop having a differently shaped opening, according to the modification. Furthermore, by disposing a pattern plate, on which a plurality of very fine patterns are formed, predetermined distance away from a plane conjugate with reticle pattern surface, instead of modifying the shape of fixed field stop 117, it is possible to decrease dispersion of the accumulated light quantity with the pattern plate.

Thus, although exposure light IL of the present embodiment is pulse light, it is not necessary to perform exposure of an integral pulse light at each point, and it is possible to optimize the shape of fixed field stop 117, because a peak level of the pulse is low. Therefore, accuracy of exposure control in a non-scanning direction is increased.

Although fly eye lens 110 is used as an optical integrator (homogenizer) coping with a multi light source image forming optical system, it is applicable to use a rod integrator (internal reflection type integrator) instead of the fly eye lens. Furthermore, although an one-stage optical integrator (a fly eye lens or a rod integrator) is used, the present invention is applicable to using a two-stage optical integrator in order to equalize illumination distribution. In the case of one-stage optical integrator like the present invention, the present invention is particularly effective because it is preferable to equalize the illuminating distribution at the incident stage to the optical integrator.

There is a case where modified illumination (that is, loop bands illumination or illumination using so-called modified light source method that utilizes illuminating light emitted from a plurality of eccentric light sources) is employed in a projection exposure apparatus having a light source of which output terminal of an optical fiber bundle 19 is a circular or elliptic shape. In the present embodiment, a diffraction optical element (DOE) is disposed on a light path so as to form a light distribution of illuminating light in a shape of concentric loop bands on a plane of incidence of fly eye lens 110 as an optical integrator. However, it is possible to produce zero output from optical fibers within a predetermined circular area or rectangular area of which the center coincides with an optical axis of the illuminating optical system, and which areas include many optical fibers of optical fiber bundle 19, or to produce relatively smaller output relative to that in an outer area of the above-mentioned area, instead of using a element such as a DOE. This is, for example, realized by turning on and off a pumping light source of optical fiber amplifiers 22, 25 of corresponding optical amplification unit 18-i. In this case, although optical loss in the above-mentioned method is larger than that in the method of using ODE, the above method has an advantage in that configuration of an optical system is simple.

Meanwhile, it is necessary to widely change illuminance (strength of an illuminating light) on a wafer, depending on sensitivity of a resist on the wafer. Then, it is possible to adjust illuminance by changing the number of optical fibers that are emitting light, among a plurality of optical fibers of optical fiber bundle 19. In this case, adjusting mechanism that controls illuminance by replacing a plurality of ND filters is not necessary. However, in this embodiment, since output terminal of optical fiber bundle 29 is located conjugated with a plane of incidence of a fly eye lens 110 as an optical integrator, when the number of optical fibers that emits light is decreased, it is preferable to decide a fiber distribution so that optical fibers that does not emit light are removed uniformly within the optical fiber bundle.

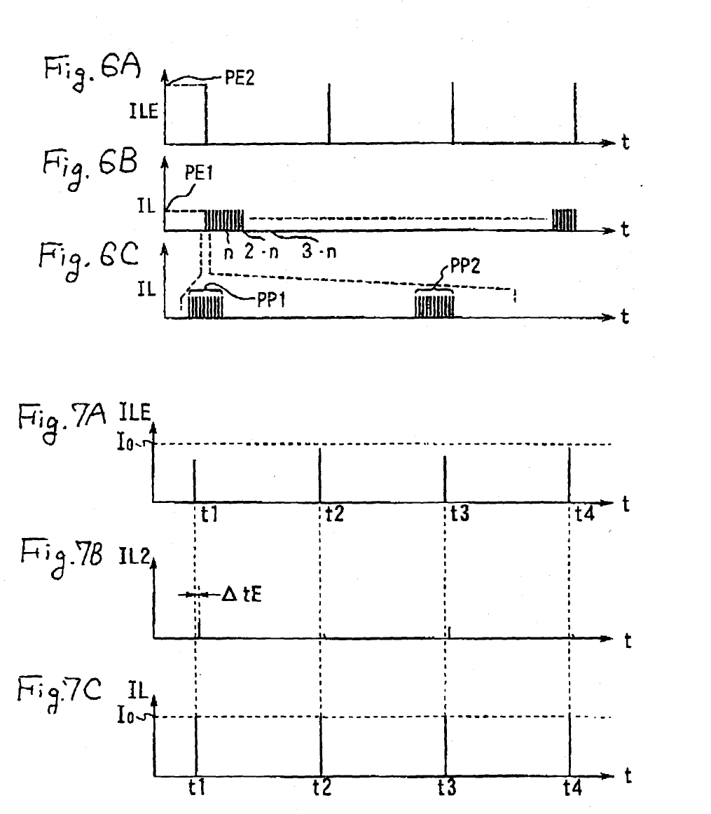

A second embodiment of the present invention is explained with the help of FIGS. 7A to 7C and FIG. 9. The present embodiment uses both of an excimer laser (or F₂ laser) light source and an optical-fiber-type light source of which the number of fibers is changeable. In FIG. 9, the same numeral is assigned to a member corresponding to that in FIG. 5, and the detailed explanation of the same member in FIG. 5 is omitted.

FIG. 9 is a explanatory view showing a projection exposure apparatus that is a step and scan type. In FIG. 9, exposure light of 193 nm ILE emitted in pulse trains from an ArF excimer laser light source 101A as a first exposure light source is turned upwardly by mirror 102A, and passes through correction lens 103C, and then transmits polarization beam splitter 102B in a P-polarized state. Meanwhile, exposure light of 193 nm IL2 emitted in pulse trains from a light source 101 as a second exposure light source is reflected by polarization beam splitter 102B in a S-polarized state, and combined with exposure light ILE in the same optical axis, and travels through a wavelength constant (not shown), and becomes exposure light IL in a circularly polarized state. This exposure light illuminates reticle R. Arrangement after lens 103A is the same as that of the embodiment in FIG. 5. In this case, correction lens 103C is arranged to cancel the influence of lenses 103A and 103B to exposure light ILE.

In the present embodiment, ArF excimer laser light source 101A emits light, for example, at a frequency of 2 kHz, and optical-fiber-type light source 101 emits at a frequency of 100 kHz, resulting in high responsibility. Accordingly, light emitted form the former light source, ArF excimer laser source 101A, is used to give most quantity of exposure light to wafer W, and light emitted from the latter light source, optical-fiber-type light source 101, is used to fills a shortage of light.

Specifically, exposure light ILE is emitted from ArF light source at slightly lower level than an adequate level Io at time t1, t2, t3, . . . . . . . At this time, integrator sensor 115 shown in FIG. 9 monitors light quantity of each pulse, and from the results of monitoring, a shortage of light quantity is calculated. Then, optical-fiber-type light source 101 emits a shortage of exposure light IL2 at a time ΔtE slightly after time t1, t2, t3, . . . as shown in FIG. 7B. This allows energy of exposure light IL to reach to target level Io at time t1, t2, t3, . . . as shown in FIG. 7C, thereby increasing accuracy of exposure light quantity at each point on wafer W.

In the case of using F₂ laser light source instead of ArF excimer laser light source 101A, it is preferable to use a wavelength of 157 nm for light source 101.

The present invention can be applied to not only a projection exposure apparatus of a step and scanning type, but also a projection exposure apparatus of full wafer exposing type (such as a stepper) and an exposure apparatus of proximity type.

The projection exposure apparatus mentioned above is build up so that each component of the apparatus is combined electrically, mechanically, and optically, adjusting illuminating optical system and projection optical system. It is preferable that these works are performed in a clean room under control of temperature conditioning.

Then, wafer W exposed to exposure light as described above is processed through a developing process, a pattern forming process, a bonding process, and a packaging process, thereby a device such as a semiconductor element being manufactured. Furthermore, the present invention is applicable to manufacture display elements such as a crystal liquid element and a plasma display element, a thin film magnetic disk, an imaging element, a micro-machine, and a DNA chip. It is also applicable to manufacture a photo mask (a reticle) for an exposure apparatus.

Although the present invention has been described above with respect to the embodiments, the invention is not limited to only these embodiments. It will be appreciated by those skilled in the art that changes may be made in these embodiments without departing from the principles and spirit of the invention. All disclosed contents of Japanese Patent Application No.11-259621 filed on Sep. 13, 1999, including Specification, Scope of the Claim, Drawings, and Abstract are incorporated into the present invention.

What is claimed is:

1. An exposure method in which a first object is illuminated with illumination light and with said first object and a second object being synchronously moved, said second object is scan-exposed with the illumination light that has passed a pattern on said first object, said exposure method comprising:
utilizing, as said illumination light, ultraviolet pulse light obtained by wavelength-converting pulse laser light amplified by a fiber optical amplifier;
measuring, on the optical path up to the second object, an intensity of the ultraviolet pulse light as said illumination light on a plurality-of-pulse basis or on a predetermined-time-interval basis; and
controlling an exposure amount on said second object based on the measurement results.

2. A method according to claim 1, wherein the light-emission frequency of said ultraviolet pulse light is in a range of from 10 kHz to 1 MHz.

3. An exposure method in which a first object is illuminated with illumination light from an illumination optical system, and a second object is exposed with the illumination light that has passed a pattern on said first object, said exposure method comprising:
making ultraviolet light obtained by wavelength-converting a plurality of laser lights, each of which laser lights having been amplified by a fiber optical amplifier, that are bundled into an annulus-like form said illumination light;
illuminating said first object with said illumination light when modified-illuminating said first; and
illuminating said first object with light made by smoothing the intensity distribution of said illumination light when conventional-illuminating said first object.

4. An exposure method in which a first object is illuminated with illumination light and with said first object and a second object being synchronously moved, said second object is scan-exposed with the illumination light that has passed a pattern on said first object, said exposure method comprising:
illuminating said first object with a first ultraviolet light pulse-emitted from a first light source apparatus;
generating a second ultraviolet light of substantially the same wavelength range as that of said first ultraviolet light at a pulse frequency higher than that of said first light source apparatus from a second light source apparatus that can emit light at a pulse frequency higher than that of said first light source apparatus; and
correcting, by said second ultraviolet light, an exposure amount on said second object provided by said first ultraviolet light

5. A method according to claim 4, wherein said first light source apparatus is a gas laser; and
said second light source apparatus includes a laser light generating portion that generates single-wavelength laser light of from infrared to visible range as pulse light, a light amplifying portion having a fiber optical amplifier that amplifies said laser light, and a wavelength converting portion that wavelength-converts said amplified laser into said second ultraviolet light by utilizing a nonlinear optical crystal.

6. An exposure method in which a first object is illuminated with illumination light and a second object is exposed with the illumination light that has passed a pattern on said first object, said exposure method comprising:
making ultraviolet light obtained by wavelength-converting a plurality of laser lights, each of which laser lights having been amplified by a fiber optical amplifier, that are bundled the illumination light;
and changing a condition under which said second object is illuminated with said illumination light depending upon a divergence angle condition of a plurality of light beams constituting said illumination light.

7. An exposure method in which a first object is illuminated with illumination light and with said first object and a second object being synchronously moved, said second object is scan-exposed with the illumination light that has passed a pattern on said first object, said exposure method comprising:
making ultraviolet light obtained by wavelength-converting laser light amplified by a fiber optical amplifier said illumination light;
illuminating said first object with said illumination light, with said illumination light passing via a field stop having an aperture placed on a plane substantially optically conjugate to said first object; and
also defining the shape of a edge portion, having a direction intersecting the scanning direction of said second object, of said aperture of said field stop depending upon an integrated exposure amount distribution on said second object.

8. An exposure apparatus in which a first object is illuminated with illumination light and with said first object and a second object being synchronously moved, said second object is scan-exposed with the illumination light that has passed a pattern on said first object, the exposure apparatus comprising:
a light source apparatus provided with a laser light generating portion that generates single-wavelength laser light of from infrared to visible range as pulse light, a light amplifying portion having a fiber optical amplifier that amplifies said laser light, and a wavelength converting portion that wavelength-converts said amplified laser light into ultraviolet light by utilizing a nonlinear optical crystal;
a monitoring system that measures, on the optical path up to said second object, an intensity of said ultraviolet pulse light from said light source apparatus as said illumination light on a plurality-of-pulse basis or on a predetermined-time-interval basis; and
an exposure amount control system that controls an output of said light source apparatus based on the measurement results of said monitoring system.

9. An exposure apparatus in which a first object is illuminated with illumination light from an illumination optical system, and a second object is exposed with the illumination light that has passed a pattern on said first object, wherein said illumination optical system comprises a light source apparatus provided with a laser light generating portion that generates single-wavelength laser light of from infrared to visible range as pulse light, a light branching amplifier portion that branches said laser light into a plurality of lights and amplifies each of said plurality of lights via a fiber optical amplifier, and a wavelength converting portion that wavelength-converts said amplified laser light into ultraviolet light having an annulus-like intensity distribution in a plane perpendicular to the optical axis by utilizing a nonlinear optical crystal and outputs said ultraviolet light as said illumination light; a multiple light source image forming optical system that forms a plurality of light source images from said illumination light from said light source apparatus; an optical member that is attachably placed between said light source apparatus and said multiple light source image forming optical system and smoothes an illuminance distribution of said illumination light in a plane perpendicular to the optical axis; and a light collecting optical system that illuminates said first object with said illumination light from said plurality of light source images.

10. An apparatus according to claim 9, wherein said plurality of laser light from said light branching amplifier portion are led to said wavelength converting portion via an and bundled into an annulus-like form by said optical fiber bundle.

11. An exposure apparatus in which a first object is illuminated with illumination light and with said first object and a second object being synchronously moved, said second object is scan-exposed with the illumination light that has passed a pattern on said first object, the exposure apparatus comprising:
a first light source apparatus that pulse-emits a first ultraviolet light;
a second light source apparatus that can emit a second ultraviolet light of substantially the same wavelength range as that of said first ultraviolet light at a pulse frequency higher than that of said first light source apparatus;
a combining optical system that transmits said first ultraviolet light from said first light source apparatus and said second ultraviolet light from said second light source apparatus to a common optical path pointing toward said first object as said illumination light;
a monitoring system that monitors an intensity of said illumination light on the optical path up to said second object; and
an exposure amount control system that controls light emission of said second light source so as to correct an exposure amount obtained from said pulse-emitted light of said first light source apparatus based on the measurement results of said monitoring system.

12. An exposure apparatus in which a first object is illuminated with illumination light from an illumination optical system, and a second object is exposed with the illumination light that has passed a pattern on said first object, wherein said illumination optical system comprises a light source apparatus provided with a laser light generating portion that generates single-wavelength laser light of from infrared to visible range as pulse light, a light branching amplifier portion that branches said laser light into a plurality of lights and amplifies each of said plurality of lights via a fiber optical amplifier, and a wavelength converting portion that wavelength-converts said amplified laser light into ultraviolet light by utilizing a nonlinear optical crystal and outputs said ultraviolet light as said illumination light; a multiple light source image forming optical system that forms a plurality of light source images from said illumination light from said light source apparatus; and a relay optical system that is placed between said light source apparatus and said multiple light source image forming optical system and leads said illumination light to said multiple light source image forming optical system depending upon a divergence angle condition of said plurality of light beams constituting said illumination light.

13. An exposure apparatus in which a first object is illuminated with illumination light from an illumination optical system and with said first object and a second object being synchronously moved, said second object is scan-exposed with the illumination light that has passed a pattern on said first object, wherein said illumination optical system comprises a light source apparatus provided with a laser light generating portion that generates single-wavelength laser light of from infrared to visible range as pulse light, a light amplifying portion that amplifies said laser light via a fiber optical amplifier, and a wavelength converting portion that wavelength-converts said amplified laser light into ultraviolet light by utilizing a nonlinear optical crystal and outputs said ultraviolet light as said illumination light; a light collecting optical system that illuminates said first object with said illumination light from said light source; and a field stop on which an aperture defining a field of said illumination light at a plane substantially optically conjugate to said first object, wherein the shape of a edge portion, having a direction intersecting the scanning direction of said second object, of said aperture of said field stop is defined depending upon an integrated exposure amount distribution on said second object.

14. An apparatus according to claim 13, wherein said shape of said field stop is fixed and a movable field stop for opening and closing said aperture is provided in addition to said field stop.

15. A device manufacturing method comprising a process that transfers a pattern on a mask using an exposure method according to claim 1.
